(19) United States
(12) Patent Application Publication
(10) Pub. No.: US 2019/0087445 A1
(43) Pub. Date: Mar. 21, 2019

(54) METHOD OF FACILITATING DISTRIBUTED DATA SEARCH IN A FEDERATED CLOUD AND SYSTEM THEREOF

(71) Applicant: AGENCY FOR SCIENCE, TECHNOLOGY AND RESEARCH, Singapore (SG)

(72) Inventors: Yongqing ZHU, Singapore (SG); Quanqing XU, Singapore (SG); Haixiang SHI, Singapore (SG); Juniarto SAMSUDIN, Singapore (SG)

(21) Appl. No.: 16/082,889

(22) PCT Filed: Mar. 6, 2017
(86) PCT No.: PCT/SG2017/050106

§ 371 Date: Sep. 6, 2018

(30) Foreign Application Priority Data
Mar. 7, 2016 (SG) 10201601723Q

(51) Int. Cl. G06F 17/30; H04L 29/08

(52) U.S. Cl. CPC G06F 17/30283; G06F 17/30327; G06F 17/30545; H04L 67/1097

(57) ABSTRACT

There is provided a method of facilitating distributed data search in a federated cloud. The method includes generating, at a computing cloud of the federated cloud, a search tree structure for indexing a data set in the computing cloud; mapping a selected set of nodes of the search tree structure to respective peer nodes of a peer-to-peer tree structure spanning a plurality of servers in a plurality of computing clouds of the federated cloud, the peer-to-peer tree structure configured for routing a query for searching a data item in the federated cloud; and informing, for each selected node, the plurality of types of attribute conditions associated with the selected node to the corresponding mapped peer node such that the corresponding mapped peer node has associated therewith the plurality of types of attribute conditions.

### CROSS-REFERENCE TO RELATED APPLICATION

This application claims the benefit of priority of Singapore Patent Application No. 10201601723Q, filed 7 Mar. 2016, the contents of which being hereby incorporated by reference in its entirety for all purposes.

### TECHNICAL FIELD

The present invention generally relates to a method of facilitating distributed data search in a federated cloud (or interchangeably referred to as cloud federation) and a system thereof, and more particularly, to such a method and system capable of supporting multi-attribute range queries in the federated cloud.

### BACKGROUND

Cloud computing is the paradigm to establish large-scale infrastructure and provision computation, storage, and high-level services to end users on demand. Many applications have been deployed in computing cloud (or simply referred to as “cloud” herein) to leverage the availability and scalability provided by cloud. With the growth of cloud usage, the resource and scalability provided by a single cloud provider are approaching the limits. Federated cloud has been proposed to join multiple external and internal clouds together to achieve extended resources and improved scalability, such as the deployment and management of multiple external and internal cloud computing services to match business needs. FIG. 1 depicts a schematic drawing of a federated cloud comprising a plurality of clouds. Federated cloud facilitates data sharing across geographically dispersed organizations, such as for scientific research, e.g., in genome cloud federation. For example, respective data (or data set) may be owned by individual organization/private cloud, and may lack centralized organization and control. Storing of large-scale data can be achieved by deploying distributed storage system in cloud, e.g., Amazon's Simple Storage Service (S3), etc. Data can be retrieved from huge dataset via file ID, object ID, or primary key. However, query requirements are more complicated in the real world. Users may wish to search data based on combined attributes (i.e., based on multi-attributes) with specific ranges from the cloud. However, existing distributed storage systems have no support for secondary index and cannot provide/support efficient data search with complicated query requirements, and in particular, multi-attribute range queries.

For example, there may be user requirements to search data in a cloud whereby the data is dispersed among different locations and owned by different organizations (e.g. a federated cloud). For example, gnome data may be shared across the genome clouds and there may be requirements to search genome data from various private clouds (or collaborators' clouds). Various conventional approaches/techniques are based on query flooding to perform a federated cloud search, such as illustrated in FIG. 2. However, such approaches of deploying query flooding will need to traverse all clouds in the federated cloud, which lead to excessive consumption of network bandwidth and poor scalability, as well as the possibility that the query may not be resolved. For example, as illustrated in FIG. 2, when cloud A receives a query from a user, cloud A has to broadcast the query to all other clouds in the federated cloud. On the other hand, various conventional approaches/techniques adopting structured peer-to-peer (P2P) networks have limitations in supporting complicated search features (e.g., multi-attribute range queries) and lead to high maintenance and network cost.

A need therefore exists to provide a method of facilitating distributed data search in a federated cloud and a system thereof that seek to overcome, or at least ameliorate, one or more of the deficiencies of conventional methods/techniques of facilitating distributed data search in a federated cloud. It is against this background that the present invention has been developed.

### SUMMARY

According to a first aspect of the present invention, there is provided a method of facilitating distributed data search in a federated cloud, the method comprising:

generating, at a computing cloud of the federated cloud, a search tree structure for indexing a data set in the computing cloud, the search tree structure comprising a plurality of nodes, each node being associated with a data subset of the data set and a plurality of types of attribute conditions satisfied by said data subset associated with the node;

mapping a selected set of nodes of the search tree structure to respective peer nodes of a peer-to-peer tree structure spanning a plurality of servers in a plurality of computing clouds of the federated cloud, the peer-to-peer tree structure configured for routing a query for searching a data item in the federated cloud and comprises a plurality of peer nodes, the plurality of peer nodes corresponding to the plurality of servers, respectively, in the plurality of computing clouds; and

informing, for each selected node, the plurality of types of attribute conditions associated with the selected node to the corresponding mapped peer node such that the corresponding mapped peer node has associated therewith the plurality of types of attribute conditions.

In various embodiments, each mapped peer node of the plurality of peer nodes has associated therewith routing information, the routing information comprising the plurality of types of attribute conditions informed by the corresponding selected node and a plurality of types of attribute conditions associated with each peer node of a subset of the plurality of peer nodes related to the mapped peer node.

In various embodiments, each peer node of the subset of the plurality of peer nodes related to the mapped peer node is a parent peer node, a children peer node, an adjacent peer node, or a neighbour peer node to the mapped peer node in the peer-to-peer tree structure.

In various embodiments, the routing information comprises a routing table including a peer node entry for each peer node related to the mapped peer node, each peer node entry comprising a peer node identifier of the related peer node and the plurality of types of attribute conditions associated with the related peer node.

In various embodiments, the plurality of types of attribute conditions comprises a plurality of data value boundaries for different types of data attributes.

In various embodiments, the selected set of nodes comprises children nodes of a root node of the search tree structure.

In various embodiments, mapping the selected set of nodes comprises:

performing a network cost analysis on the peer-to-peer tree structure associated with mapping the selected set of nodes to the respective peer nodes of the peer-to-peer tree structure; and

adjusting the selected set of nodes for mapping to the respective peer nodes based on the network cost analysis.

In various embodiments, performing the network cost analysis comprises:

determining, for the selected set of nodes, a network cost on the peer-to-peer tree structure associated with mapping the selected set of nodes to the respective peer nodes of the peer-to-peer tree structure;

determining, for a second set of nodes of the search tree structure, a network cost on the peer-to-peer tree structure associated with mapping the second set of nodes to the respective peer nodes of the peer-to-peer tree structure, the second set of nodes being the selected set of nodes with one or more selected nodes thereof replaced by corresponding one or more children nodes thereof;

comparing the network cost determined for the selected set of nodes with the network cost determined for the second set of nodes; and

adjusting the selected set of nodes to conform with the second set of nodes if the network cost determined for the second set of nodes is lower than the network cost determined for the selected set of nodes.

In various embodiments, determining the network cost for the selected set of nodes comprises determining an index maintenance cost on the peer-to-peer tree structure associated with the selected set of nodes, wherein the index maintenance cost is determined based on, for each of the selected set of nodes, a probability of an event occurring on the selected node.

In various embodiments, the index maintenance cost is determined based on, for each of the selected set of nodes, respective probabilities of a plurality of types of events occurring on the selected node, the plurality of types of events comprising a node splitting event whereby the selected node splits in the search tree structure, a node merging event whereby the selected node merges with another node in the search tree structure, and a rebalancing event whereby the search tree structure is caused to rebalance by the splitting or merging event on the selected node.

In various embodiments, the peer-to-peer tree structure is a Balanced Tree Overlay Network (BATON) tree structure.

According to a second aspect of the present invention, there is provided a system for facilitating distributed data search in a federated cloud, the system comprising:

a search tree generator module configured to generate, at a computing cloud of the federated cloud, a search tree structure for indexing a data set in the computing cloud, the search tree structure comprising a plurality of nodes, each node being associated with a data subset of the data set and a plurality of types of attribute conditions satisfied by said data subset associated with the node;

a mapping module configured to map a selected set of nodes of the search tree structure to respective peer nodes of a peer-to-peer tree structure spanning a plurality of servers in a plurality of computing clouds of the federated cloud, the peer-to-peer tree structure configured for routing a query for searching a data item in the federated cloud and comprises a plurality of peer nodes, the plurality of peer nodes corresponding to the plurality of servers, respectively, in the plurality of computing clouds; and

an attribute condition informing module configured to inform, for each selected node, the plurality of types of attribute conditions associated with the selected node to the corresponding mapped peer node such that the corresponding mapped peer node has associated therewith the plurality of types of attribute conditions.

In various embodiments, each mapped peer node of the plurality of peer nodes has associated therewith routing information, the routing information comprising the plurality of types of attribute conditions informed by the corresponding selected node and a plurality of types of attribute conditions associated with each peer node of a subset of the plurality of peer nodes related to the mapped peer node.

In various embodiments, the routing information comprises a routing table including a peer node entry for each peer node related to the mapped peer node, each peer node entry comprising a peer node identifier of the related peer node and the plurality of types of attribute conditions associated with the related peer node.

In various embodiments, the plurality of types of attribute conditions comprises a plurality of data value boundaries for different types of data attributes.

In various embodiments, the mapping module is further configured to:

perform a network cost analysis on the peer-to-peer tree structure associated with mapping the selected set of nodes to the respective peer nodes of the peer-to-peer tree structure; and

adjust the selected set of nodes for mapping to the respective peer nodes based on the network cost analysis.

In various embodiments, performing the network cost analysis comprises:

determining, for the selected set of nodes, a network cost on the peer-to-peer tree structure associated with mapping the selected set of nodes to the respective peer nodes of the peer-to-peer tree structure;

determining, for a second set of nodes of the search tree structure, a network cost on the peer-to-peer tree structure associated with mapping the second set of nodes to the respective peer nodes of the peer-to-peer tree structure, the second set of nodes being the selected set of nodes with one or more selected nodes thereof replaced by corresponding one or more children node thereof;

comparing the network cost determined for the selected set of nodes with the network cost determined for the second set of nodes; and

adjusting the selected set of nodes to conform with the second set of nodes if the network cost determined for the second set of nodes is lower than the network cost determined for the selected set of nodes.

In various embodiments, determining the network cost for the selected set of nodes comprises determining an index maintenance cost on the peer-to-peer tree structure associated with the selected set of nodes, wherein the index maintenance cost is determined based on, for each of the selected set of nodes, a probability of an event occurring on the selected node.

In various embodiments, the index maintenance cost is determined based on, for each of the selected set of nodes, respective probabilities of a plurality of types of events occurring on the selected node, the plurality of types of events comprising a node splitting event whereby the selected node splits in the search tree structure, a node merging event whereby the selected node merges with another node in the search tree structure, and a rebalancing event whereby the search tree structure is caused to rebalance by the splitting or merging event on the selected node.

According to a third aspect of the present invention, there is provided a computer program product, embodied in one or more computer-readable storage mediums, comprising instructions executable by one or more computer processors to perform a method of facilitating distributed data search in a federated cloud, the method comprising:

generating, at a computing cloud of the federated cloud, a search tree structure for indexing a data set in the computing cloud, the search tree structure comprising a plurality of nodes, each node being associated with a data subset of the data set and a plurality of types of attribute conditions satisfied by said data subset associated with the node;

mapping a selected set of nodes of the search tree structure to respective peer nodes of a peer-to-peer tree structure spanning a plurality of servers in a plurality of computing clouds of the federated cloud, the peer-to-peer tree structure configured for routing a query for searching a data item in the federated cloud and comprises a plurality of peer nodes, the plurality of peer nodes corresponding to the plurality of servers, respectively, in the plurality of computing clouds; and

informing, for each selected node, the plurality of types of attribute conditions associated with the selected node to the corresponding mapped peer node such that the corresponding mapped peer node has associated therewith the plurality of types of attribute conditions.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a schematic drawing of a federated cloud comprising a plurality of clouds;

FIG. 2 illustrates a conventional approach of performing a federated cloud search based on query flooding;

FIG. 3 depicts a flow diagram of a method of facilitating distributed data search in a federated cloud according to various embodiments of the present invention;

FIG. 4 depicts a schematic drawing of a system for facilitating distributed data search in a federated cloud according to various embodiments of the present invention;

FIG. 5 depicts a schematic drawing of an exemplary computer system;

FIG. 6 depicts a schematic flow diagram illustrating a distributed search (three-layer) method in a federated cloud according to various example embodiments of the present invention;

FIG. 7A depicts a schematic drawing illustrating the mapping of selected nodes from search trees to respective peers of a P2P BATON tree according to various example embodiments of the present invention;

FIG. 7B depicts an exemplary routing table associated with a peer in the peer-to-peer tree for illustration purposes only according to various example embodiments of the present invention;

FIG. 8A depicts a schematic drawing illustrating an example case of index completeness and an example case of failing index completeness according to various example embodiments of the present invention;

FIG. 8B depicts a schematic drawing illustrating an example case of index uniqueness and an example case of failing index uniqueness according to various example embodiments of the present invention;

FIG. 9 depicts a schematic drawing illustrating node selection adjustment according to various example embodiments of the present invention;

FIGS. 10A and 10B depict a transition table and a graph, respectively, illustrating a three-state Markov chain model for determining network cost according to various example embodiments of the present invention;

FIG. 10C illustrates the relationship of the query space of query q, the data space of node n, the result set returned by node n, and the false positives according to various example embodiments of the present invention;

FIGS. 11A to 11F depict graphs showing performance comparison of splitting times (i.e., number of times of node splitting) associated with three different cloud indexing approaches: DS-index without cost model, DS-index with cost model, and CG-index with cost model, based on experiments conducted;

FIGS. 12A and 12B depict graphs showing the performance improvement in splitting times associated with the DS-index with cost model approach based on experiments conducted;

FIGS. 13A to 13F depict graphs showing performance comparison of merging times (i.e., number of times of node merging) associated with the same three different cloud indexing approaches based on experiments conducted;

FIGS. 14A and 14B depict graphs showing the performance improvement in merging times associated with the DS-index with cost model approach based on experiments conducted;

FIG. 15 depicts a graph showing rebalancing comparison between DS-index with cost model and DS-index without cost model based on experiments conducted;

FIG. 16 depicts a graph shows the network costs for DS-index without cost model and DS-index with cost model based on experiments conducted;

FIG. 17 depicts a schematic drawing of a federated cloud comprising multiple private clouds for different departments or organizations, along with a routing tree based on a P2P BATON tree, and a query forwarding route for a multi-attribute range query according to various example embodiments of the present invention; and

FIG. 18 depicts a schematic drawing of a federated cloud comprising three private clouds at three different organizations, each private cloud having a system deployed therein for facilitating distributed data search in the federated cloud, according to various example embodiments of the present invention.

### DETAILED DESCRIPTION

As discussed in the background, there may be requirements to search data across various computing clouds (or simply referred to as “clouds”) in a federated cloud (or interchangeably referred to as cloud federation) for various purposes, e.g., whereby data is dispersed among different locations in various clouds and may be owned by different organizations. For example, gnome data may be shared across the genome clouds and there may be requirements to search genome data from various private clouds (or collaborators' clouds), such as to obtain certain data. However, conventional methods, such as those as mentioned in the background, are not able to support efficient data search with more complicated query requirements (e.g., multi-dimension/multi-attribute range queries). In this regard, embodiments of the present invention provide a method of facilitating distributed data search in a federated cloud and a system thereof, and more particularly, to such a method and system capable of supporting multi-attribute range queries in the federated cloud.

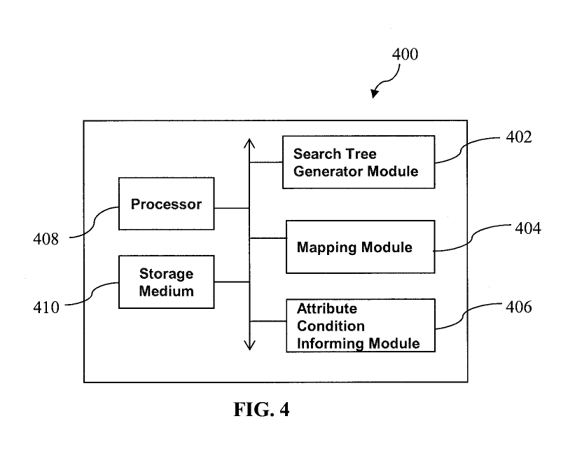

FIG. 3 depicts a flow diagram of a method 300 of facilitating distributed data search in a federated cloud according to various embodiments of the present invention. The method 300 comprises a step 302 of generating, at a computing cloud of the federated cloud, a search tree structure for indexing a data set in the computing cloud, the search tree structure comprising a plurality of nodes, each node being associated with a data subset of the data set and a plurality of types of attribute conditions (or may interchangeably be referred to as multi-attribute conditions herein) satisfied by said data subset associated with the node, a step 304 of mapping a selected set of nodes of the search tree structure to respective peer nodes of a peer-to-peer (P2P) tree structure spanning a plurality of servers in a plurality of computing clouds of the federated cloud, the peer-to-peer tree structure configured for routing a query for searching a data item in the federated cloud and comprises a plurality of peer nodes, the plurality of peer nodes corresponding to the plurality of servers, respectively, in the plurality of computing clouds, and a step 306 of informing, for each selected node, the plurality of types of attribute conditions associated with the selected node to the corresponding mapped peer node such that the corresponding mapped peer node has associated therewith the plurality of types of attribute conditions.

Therefore, according to the method 300, a search tree structure may first be generated for indexing a data set in a computing cloud (e.g., private cloud) of the federated cloud, and a selected set of nodes of the search tree structure may then be mapped to respective peer nodes of a P2P tree structure configured for routing a query which spans across various servers in multiple computing clouds (e.g., private clouds, each having associated therewith a respective data set). In particular, for each selected node, the multi-attribute conditions associated with the selected node may be informed (e.g., published) to the corresponding mapped peer node such that the corresponding mapped peer node has associated therewith the multi-attribute conditions. In various embodiments, the multi-attribute conditions may comprise a plurality of data value boundaries (or data value ranges) for different types of data attributes. Thus, the P2P tree structure having nodes mapped with multi-attribute conditions (e.g., plurality or group of data value boundaries for different types of data attributes) from various search tree structures of various clouds in the federated cloud, the P2P tree structure may advantageously be able to efficiently route a query through various peer nodes (e.g., based on whether the attribute conditions associated with the current peer node overlaps with the search space of the query), and thus through corresponding servers across multiple clouds in the federated cloud for searching for a data item based on a plurality of types of data attributes (e.g., data having attributes satisfying the plurality of types of data attributes included in the query). For example and without limitations, the plurality of types of data attributes may include data size, data created or modified date, data type (e.g., JPEG, PDF, etc.), data name, and so on.

In various embodiments, each mapped peer node of the plurality of peer nodes has associated therewith routing information, the routing information comprising a plurality of types of attribute conditions associated with each peer node of a subset of the plurality of peer nodes related to the mapped peer node. The routing information may further comprise the plurality of types of attribute conditions informed by the corresponding selected node to the mapped peer node. For example, the mapped peer node may have a number of related peer nodes, and the routing information associated with the mapped peer node may include the multi-attribute conditions published by the corresponding selected node to the mapped peer node, and the multi-attribute conditions associated with each of the related peer nodes. In various embodiments, the routing information may comprise a routing table including a peer node entry for each peer node related to the mapped peer node, each peer node entry comprising a peer node identifier (ID) of the related peer node and the plurality of types of attribute conditions associated with the related peer node (thus the multi-attribute conditions are linked to the corresponding peer node ID). In various embodiments, a peer node is related to the mapped peer node if the peer node is any one of a parent peer node, a children peer node, an adjacent/sibling peer node, or a neighbour peer node to the mapped peer node in the P2P tree structure. It can be understand by a person skilled in the art that given a peer node in a P2P tree (e.g., a P2P Baton tree), an adjacent peer node is the peer node that is either immediately prior to it or immediately after it in the traversal. An in-order traversal helps to build the linear ordering in the P2P Baton tree (e.g., see H. V. Jagadish et al., “BATON: A Balanced Tree Structure for Peer-to-Peer Networks”, In VLDB, pages 611-672, 2005, the contents of which being hereby incorporated by reference in its entirety for all purposes). A neighbour peer node is a peer node in the P2P tree that is at the same level as the given peer node.

Accordingly, for example, a server (corresponding to a peer node) may receive a query, the server may then refer to the routing information associated with the corresponding peer node to determine whether the server can contribute to the query (e.g., overlaps with the search space of the query) based on the multi-attribute conditions associated with the corresponding peer node, and whether any of the related peer nodes (related servers) of the corresponding peer node can contribute to the query. If the multi-attribute conditions (e.g., data value boundaries) associated with the server receiving the query overlaps with the search space/criterion of the query, the server may then proceed to search for data in the data set associated therewith that satisfies the search space/criterion of the query. The server may also forward the query to any of its related servers based on the P2P tree structure having multi-attribute conditions (e.g., data value boundaries) overlapping with the search space of the query. Accordingly, with the mapping of selected set of nodes of the search tree to respective peer nodes of a P2P tree structure spanning multiple servers across multiple clouds and informing, for each selected node, the multi-attribute conditions associated with the selected node to the corresponding mapped peer node for enabling query routing/forwarding, desired data can be searched across the federated cloud based on a multi-attribute query, including a multi-attribute range query in an efficient manner, which minimizes network bandwidth consumption and enhances scalability. By way of an example, a multi-attribute range query may include multi-attribute conditions (e.g., data value boundaries) such as {size between (100 KB, 1 GB); date between (01/01/2015, 30/06/2015); type=“WGS”; organism=“Zebrafish”}.

In various embodiments, mapping the selected set of nodes comprises performing a network cost analysis on the P2P tree structure associated with mapping the selected set of nodes to the respective peer nodes of the P2P tree structure, and adjusting the selected set of nodes for mapping to the respective peer nodes based on the network cost analysis. By performing a network cost analysis of the selected set of nodes and adjusting them for mapping to respective peer nodes of the P2P tree structure, network cost may advantageously be reduced, such as a reduction in network traverse with less network bandwidth consumption. In various embodiments, performing the network cost analysis may comprise determining, for the selected set of nodes, a network cost on the peer-to-peer tree structure associated with mapping the selected set of nodes to the respective peer nodes of the peer-to-peer tree structure; determining, for a second set of nodes of the search tree structure, a network cost on the peer-to-peer tree structure associated with mapping the second set of nodes to the respective peer nodes of the peer-to-peer tree structure, the second set of nodes being the selected set of nodes with one or more selected nodes thereof replaced by corresponding one or more children nodes thereof (i.e., the second set of nodes may be the same as the selected set of nodes except one or more nodes which is/are one or more children nodes of one or more selected nodes instead of being the same as the one or more selected nodes); comparing the network cost determined for the selected set of nodes with the network cost determined for the second set of nodes; and adjusting the selected set of nodes to conform with the second set of nodes (e.g., by replacing the selected nodes in the selected set of nodes with (i.e., to be the same as) the nodes in the second set of nodes) if the network cost determined for the second set of nodes is lower than the network cost determined for the selected set of nodes. In various embodiments, the comparison of the network costs between a selected node and its children node(s) may continue until the leaf nodes of the search tree structure. Thus, according to various embodiments of the present invention, the nodes selected for mapping may be dynamically adjusted during the operation of the federated cloud to reduce/minimize network cost.

In various embodiments, determining the network cost for the selected set of nodes comprises determining an index maintenance cost on the P2P tree structure associated with the selected set of nodes. In this regard, the index maintenance cost may be determined based on, for each of the selected set of nodes, a probability of an event occurring on the selected node, or respective probabilities of a plurality of types of events occurring on the selected node. In various embodiments, the plurality of types of events may comprise a node splitting event whereby the selected node splits in the search tree structure, a node merging event whereby the selected node merges with another node in the search tree structure, and a rebalancing event whereby the search tree structure is caused to rebalance by the splitting or merging event on the selected node.

Accordingly, the method of facilitating distributed data search in a federated cloud according to various embodiments of the present invention is able to achieve federated data search across clouds with dynamic mapping between the search tree structure and the P2P tree structure, thereby reducing/minimising network cost with fewer message exchanges and less network bandwidth consumption, thus improving data search efficiency and scalability.

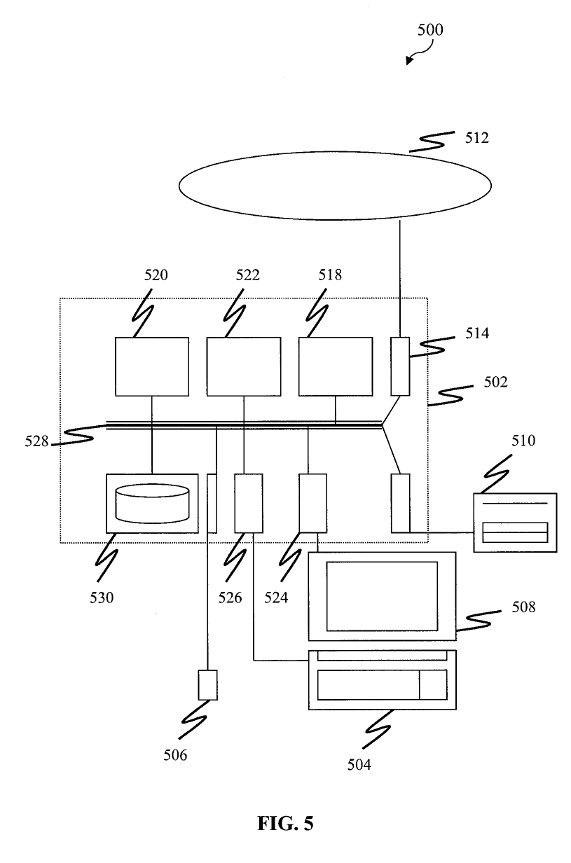

FIG. 4 depicts a schematic drawing of a system 400 for facilitating distributed data search in a federated cloud according to various embodiments of the present invention. The system 400 comprises a search tree generator module/circuit 402 configured to generate, at a computing cloud of the federated cloud, a search tree structure for indexing a data set in the computing cloud, the search tree structure comprising a plurality of nodes, each node being associated with a data subset of the data set and a plurality of types of attribute conditions satisfied by said data subset associated with the node, a mapping module/circuit 404 configured to map a selected set of nodes of the search tree structure to respective peer nodes of a peer-to-peer tree structure spanning a plurality of servers in a plurality of computing clouds of the federated cloud, the peer-to-peer tree structure configured for routing a query for searching a data item in the federated cloud and comprises a plurality of peer nodes, the plurality of peer nodes corresponding to the plurality of servers, respectively, in the plurality of computing clouds, an attribute condition informing module/circuit 406 configured to inform, for each selected node, the plurality of types of attribute conditions associated with the selected node to the corresponding mapped peer node such that the corresponding mapped peer node has associated therewith the plurality of types of attribute conditions. The system 400 may further comprise a computer processor 408 capable of executing computer executable instructions (e.g., the search tree generator module 402, the mapping module 404, and/or the attribute condition informing module 406) to perform one or more functions or methods (e.g., to generate, at a computing cloud of the federated cloud, a search tree structure for indexing a data set in the computing cloud), and a computer-readable storage medium 410 communicatively coupled to the processor 408 having stored therein one or more sets of computer executable instructions (e.g., the search tree generator module 402, the mapping module 404, and/or the attribute condition informing module 406). In various embodiments, the system 400 may be configured to manage a cloud (e.g., a private cloud) in the federated cloud, such as a computer server. Therefore, in the federated cloud, multiple systems 400 may be provided, such as a system 400 for each cloud in the federated cloud.

A computing system, a controller, a microcontroller or any other system providing a processing capability may be presented according to various embodiments in the present disclosure. Such a system may be taken to include one or more processors and one or more computer-readable storage mediums. For example, as mentioned above, the system 400 described herein includes a processor (or controller) 408 and a computer-readable storage medium (or memory) 410 which are for example used in various processing carried out therein as described herein. A memory or computer-readable storage medium used in various embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as Java. Any other kind of implementation of the respective functions which will be described in more detail below may also be understood as a “circuit” in accordance with various alternative embodiments. Similarly, a “module” may be a portion of a system according to various embodiments in the present invention and may encompass a “circuit” as above, or may be understood to be any kind of a logic-implementing entity therefrom.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “computing”, “determining”, “replacing”, “generating”, or the like, refer to the actions and processes of a computer system, or similar electronic device, that manipulates and transforms data represented as physical quantities within the computer system into other data similarly represented as physical quantities within the computer system or other information storage, transmission or display devices.

The present specification also discloses a system or an apparatus for performing the operations/functions of the methods described herein. Such a system or apparatus may be specially constructed for the required purposes, or may comprise a general purpose computer or other device selectively activated or reconfigured by a computer program stored in the computer. The algorithms presented herein are not inherently related to any particular computer or other apparatus. Various general purpose machines may be used with computer programs in accordance with the teachings herein. Alternatively, the construction of more specialized apparatus to perform the required method steps may be appropriate.

In addition, the present specification also at least implicitly discloses a computer program or software/functional module, in that it would be apparent to the person skilled in the art that the individual steps of the methods described herein may be put into effect by computer code. The computer program is not intended to be limited to any particular programming language and implementation thereof. It will be appreciated that a variety of programming languages and coding thereof may be used to implement the methods/techniques of the disclosure contained herein. Moreover, the computer program is not intended to be limited to any particular control flow. There are many other variants of the computer program, which can use different control flows without departing from the spirit or scope of the invention. It will be appreciated to a person skilled in the art that various modules described herein (e.g., the search tree generator module 402, the mapping module 404, and/or the attribute condition informing module 406) may be software module(s) realized by computer program(s) or set(s) of instructions executable by a computer processor to perform the required functions, or may be hardware module(s) being functional hardware unit(s) designed to perform the required functions. It will also be appreciated that a combination of hardware and software modules may be implemented.

Furthermore, one or more of the steps of the computer program/module or method may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer program when loaded and executed on such a general-purpose computer effectively results in an apparatus that implements the steps of the methods described herein.

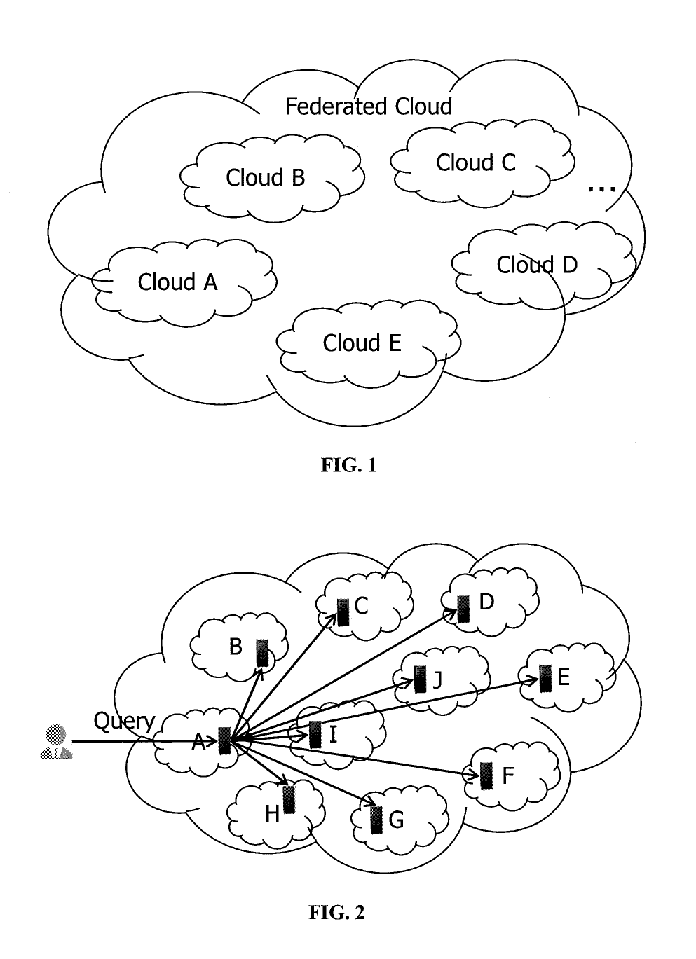

In various embodiments, there is provided a computer program product, embodied in one or more computer-readable storage mediums (non-transitory computer-readable storage medium), comprising instructions (e.g., the search tree generator module 402, the mapping module 404, and/or the attribute condition informing module 406) executable by one or more computer processors to perform a method 100 of facilitating distributed data search in a federated cloud as described hereinbefore with reference to FIG. 1 or other method(s) described herein. Accordingly, various computer programs or modules described herein may be stored in a computer program product receivable by a computer system or electronic device (e.g., system 400) therein for execution by a processor of the computer system or electronic device to perform the respective functions.

The software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the software or functional module(s) described herein can also be implemented as a combination of hardware and software modules.

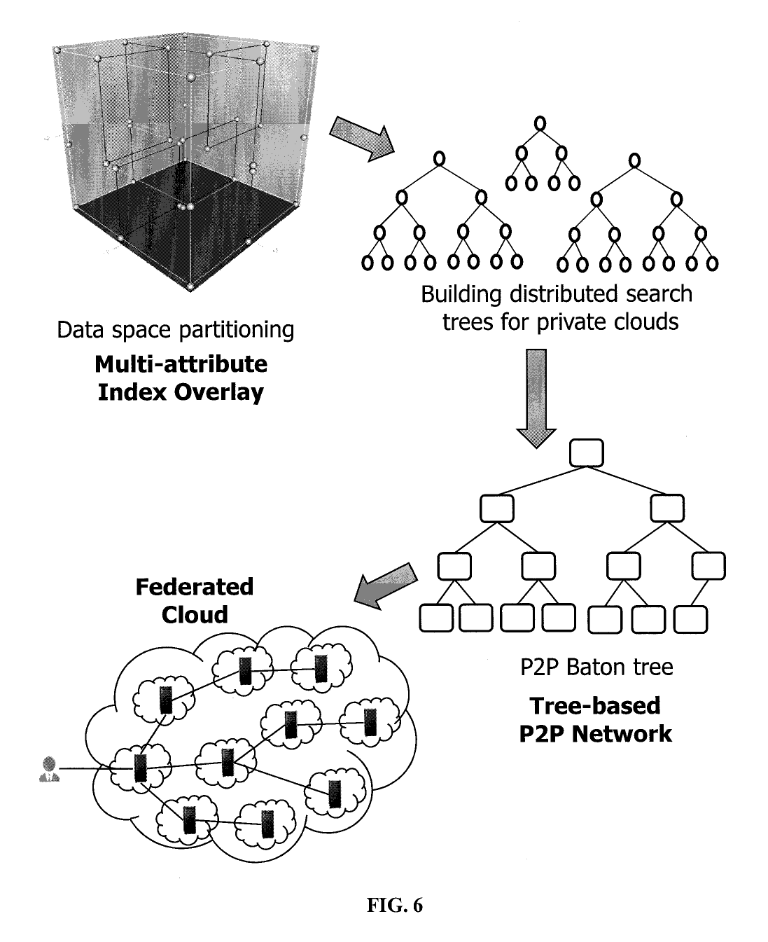

The methods or functional modules of the various example embodiments as described hereinbefore may be implemented on a computer system, such as a computer system 500 as schematically shown in FIG. 5 as an example only. In other words, it can be appreciated that the system 400 may be realized by a computer system. The method or functional module may be implemented as software, such as a computer program being executed within the computer system 500, and instructing the computer system 500 (in particular, one or more processors therein) to conduct the methods/functions of various example embodiments. The computer system 500 may comprise a computer module 502, input modules such as a keyboard 504 and mouse 506 and a plurality of output devices such as a display 508, and a printer 510. The computer module 502 may be connected to a computer network 512 via a suitable transceiver device 514, to enable access to e.g. the Internet or other network systems such as Local Area Network (LAN) or Wide Area Network (WAN). The computer module 502 in the example may include a processor 518 for executing various instructions, a Random Access Memory (RAM) 520 and a Read Only Memory (ROM) 522. The computer module 502 may also include a number of Input/Output (I/O) interfaces, for example I/O interface 524 to the display 508, and I/O interface 526 to the keyboard 504. The components of the computer module 502 typically communicate via an interconnected bus 528 and in a manner known to the person skilled in the relevant art.

It will be appreciated to a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

Various embodiments of the present invention generally relate to distributed data search in a federated cloud, which supports complicated/complex search requirements (e.g., multi-attribute range queries) using P2P networks. In this regard, various embodiments of the present invention are capable of accommodating/handling complicated/complex search requirements in a distributed environment and meanwhile reduce the cost for a scalable and efficient data search solution.

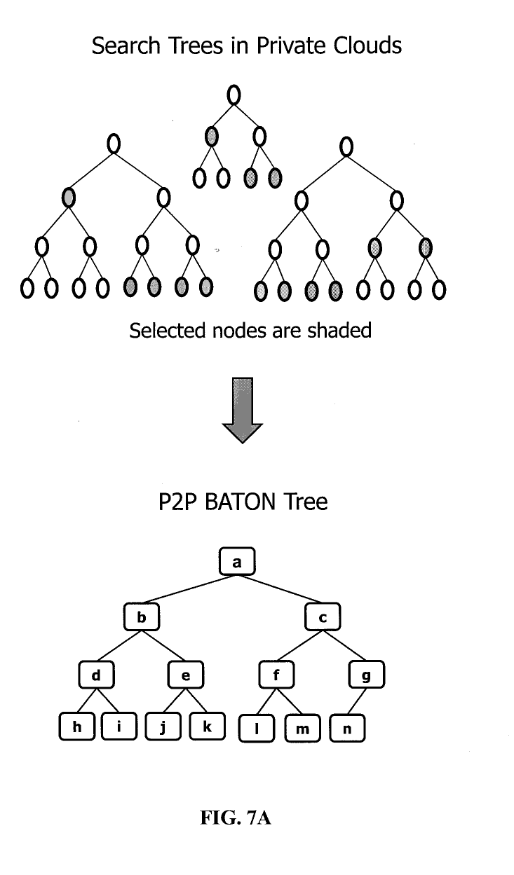

In various example embodiments, a DS-index solution/method for distributed data search in a federated cloud is provided (where “DS” stands for Distributed Search), targeting to support multi-attribute range queries with secondary index. A secondary index provides a way to efficiently access data by means of certain/secondary information other than the primary information/key. For example, primary key may be the file ID used to access files, or the object ID used to access objects. In various example embodiments, the secondary index may refer to the combined attributes (multi-attributes) used to search data for multi-attribute range queries in the cloud, for example and without limitation, the combined “organization”, “name”, and “size” attributes. FIG. 6 depicts a schematic drawing showing a system overview of the DS-index method according to various example embodiments of the present invention. As shown in FIG. 6, the DS-index method may generally include a three-layer architecture with: 1) a multi-attribute index overlay providing data indexing and multi-attribute range search capabilities within a cloud (e.g., private cloud), 2) a tree-based P2P network layer supporting query forwarding and routing across the clouds, and 3) a federated cloud layer providing connectivity (e.g., physical connection) within a cloud and between clouds. In addition, a mapping algorithm/method (in particular, a dynamic mapping algorithm/method) is provided for the DS-index method, to map between different layers thereof (in particular, between nodes of the search tree of the multi-attribute index overlay and peers (peer nodes) of the tree-based P2P network layer). In further example embodiments, a cost model (e.g., a Markov Chain-based cost model) is defined or implemented to facilitate node selection and mapping. As shown in FIG. 6, each layer may be responsible for providing specific/respective functions separately.

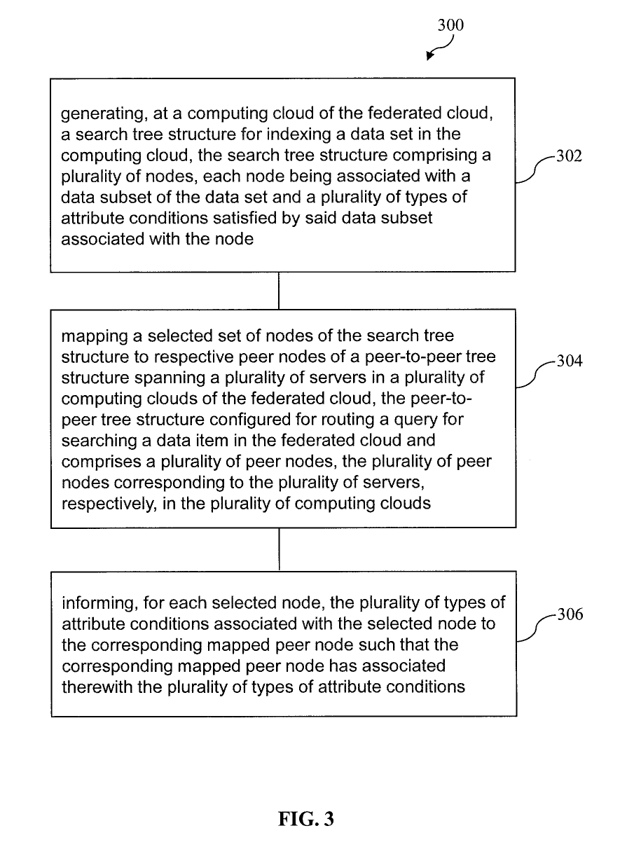

The DS-index method is capable of supporting multi-attribute range queries in the federated cloud. For example, compared to the traditional query flooding methods, e.g., as illustrated in FIG. 2, the DS-index method is more efficient and scalable as the method has been found to reduce network traverses with less network bandwidth consumption. Furthermore, with the mapping algorithms and cost model, the DS-index method has been found to be more cost-effective than the traditional P2P networks as the method reduces the network cost, e.g., in terms of index maintenance cost and node selection cost. Various experiments conducted have also demonstrated that the DS-index method with cost model can additionally save the computation resource and reduce network bandwidth consumption by around 30% compared to the DS-index without cost model. Through various experiments performed, the DS-index method has also been found to reduce the node splitting/merging times by around 20% compared to the existing CG-index solution, for example, as described in Sai Wu et. al., “Efficient B-tree based indexing for cloud data processing”, VLDB 2010, pp. 1207-1218.

Various components/layers of the DS-index method will now be described below according to various example embodiments of the present invention.

### Multi-Attribute Index Overlay

The multi-attribute index overlay may be dedicated to indexing data and providing complicated search features in each private cloud. In order to support multi-attribute range queries, the data may be indexed and multi-dimensional search trees may be built/generated accordingly. In each private cloud, the data space may be partitioned along different dimensions (different attributes). Then, a multi-dimensional index/search tree (e.g., corresponding to “search tree structure” described hereinbefore) may be built according to the space partitioning. In particular, the data is indexed by a multi-dimensional tree in each private cloud, so that multi-attribute range queries can be achieved within the cloud. It will be appreciated that various types/kinds of multi-dimensional trees known in the art can be deployed/implemented, such as KD-tree (e.g., see J. L. Bentley, “Multidimensional Binary Search Trees Used for Associative Searching”, Communications of the ACM, vol. 18, no. 9, pp. 509-517, 1975), KDB-tree (e.g., see J. T. Robinson, “The K-D-B Tree: a Search Structure for Large Multi-dimensional Dynamic Indexes”, SIGMOD 1981, pp. 10-18), R-tree (e.g., see A. Guttman, “R-Trees: A Dynamic Index Structure for Spatial Searching”, in Proc. of ACM SIGMOD'84, pp. 47-57, 1984), and so on, and the present invention is not limited to any specific type/kind of multi-dimensional search tree. Such multi-dimensional search trees may also be referred to as distributed search trees as they are dispersed in the federated cloud with each private cloud having one search tree. It will be appreciated that search trees for different clouds may have different fan-outs and depths, because the data in different clouds may have different scales and distribution. Furthermore, the search tree may be updated when there are data updates in the cloud, including new data insertion and old data deletion.

A search tree comprises or consists of a group of nodes, including internal nodes (the root node and the intermediate nodes) and leaf nodes. Data may be included in (or associated with) both the internal nodes and the leaf nodes, or included in (or associated) with the leaf nodes only, depending on the type of multi-dimensional tree utilized. Thus, each node contains (or is associated with) a subset of data that is located in (or associated with) the node and its descendant/children nodes. That is, data is located in the node and its descendant/children nodes, and the node contains a subset of such data. Moreover, each node is coupled with a group of data value boundaries (e.g., corresponding to the “plurality of types of attribute conditions” described hereinbefore), which correspond to the multiple attributes (secondary index) of data located in (or associated with) the node. For example, node A may contain a subset of data with two types of data attributes, such as “size” and “name”. For example, the maximum attribute values of the subset of data may be 100 MB and “Peter”, and the minimum attribute values of the subset of data may be 1 MB and “John”. In this regard, node A may be referred to as being coupled with (or having) a group of data value boundaries: [1 MB, 100 MB], and [“John”, “Peter”].

### Tree-Based P2P Network

The tree-based P2P network layer is configured for (or is responsible for) query forwarding and routing between clouds in the federated cloud. Various example embodiments of the present invention adopt a tree-based P2P network. For example, the P2P tree structure is capable of supporting range queries with each peer (peer node) being mapped (or managing) some data with a range of values. On the other hand, for example, DHT-based (Distributed Hash Table) structure such as Chord (I. Stoica, et al., “Chord: A Scalable Peer-to-peer Lookup Service for Internet Applications”, In SIGCOMM 2001, pages 149-160) and Mercury (Bharambe, et al., “Mercury: Supporting Scalable Multi-Attribute Range Queries”, In SIGCOMM, 2004) is not suitable for range queries because hashing destroys the ordering of data in physical location. In particular, various embodiments of the present invention employ a P2P BATON (BAlanced Tree Overlay Network) tree (e.g., as described in the above-mentioned reference, H. V. Jagadish et al.) in the tree-based P2P network layer. A BATON tree comprises or consists of a group of peers (peer nodes) that are built from servers across the federated cloud. According to various example embodiments, each peer maintains routing information to the related peers, whose corresponding servers may come from the same cloud or different clouds. The related peers may be the parent peers, children peers, sibling/adjacent peers, and neighbor peers to the peer in the BATON tree.

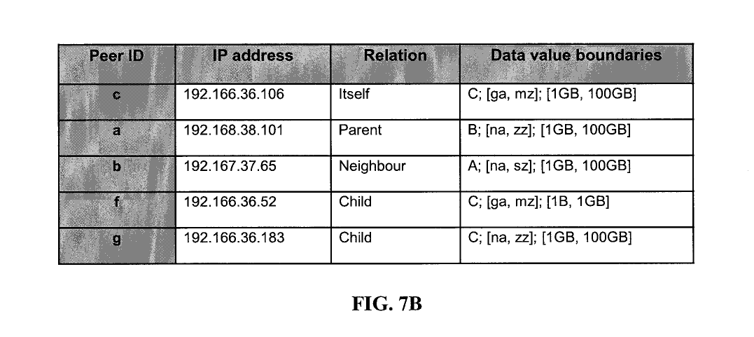

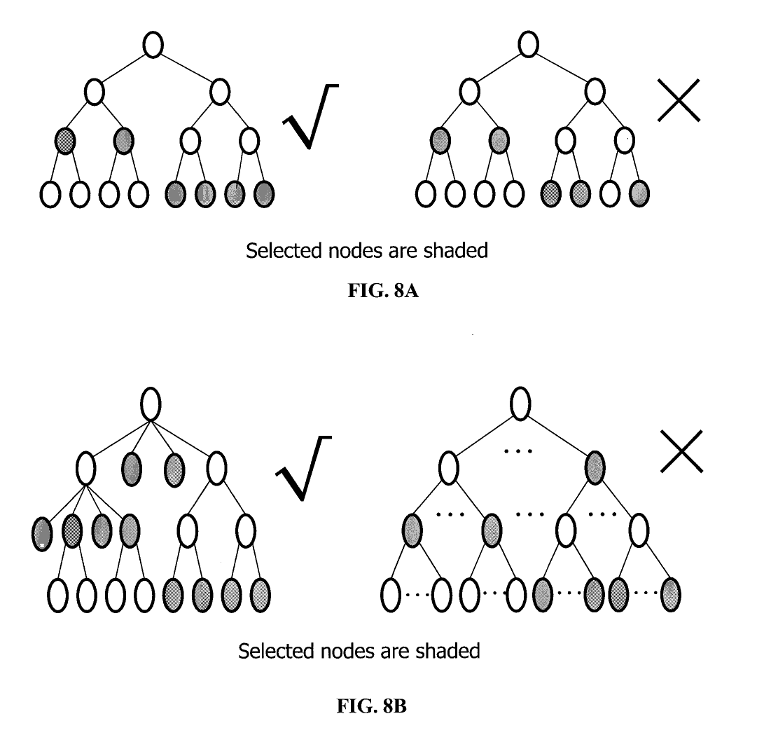

In various embodiments, each peer in the BATON tree is corresponding to a node from the distributed search trees. Moreover, when a node from a distributed search tree is mapped to a peer in the BATON tree, the data value boundaries of that node are published to the peer. Each peer has (or is associated therewith) a routing table to store/maintain data value boundary information for itself and the related peers. As an exemplary illustration only and without limitation, FIG. 7A depicts a schematic drawing showing the mapping of selected nodes from search trees to respective peers of a P2P BATON tree. As an example, three organizations referred to as A, B, and C may exist in the cloud federation, with each organization having a private cloud. In each private cloud, a multi-dimensional search tree is built for local data search. Certain nodes are selected from each search tree and mapped into the P2P BATON tree (e.g., as shown in FIG. 7A) for distributed data search. Each node in the search tree contains a subset of data, and each data is described by or associated with multiple types of attributes, such as organization, name, and data size. Each mapped peer in the BATON tree has associated therewith routing information (e.g., routing table) and FIG. 7B depicts an exemplary routing table associated with peer c in the BATON tree as an example. As shown, the routing table for peer c includes various information associated with its related peers, namely, peers a, b, f, and g. For example, for each related peer, the routing table stores the related peer ID, IP address of the related peer, relation to the related peer, and data value boundaries (plurality of types of attribute conditions) that include the data value/range of each attribute, such as organization (e.g., organization B), name (e.g., na to zz), and data size (e.g., 1 GB to 100 GB) satisfied by the data subset associated with that related peer.

Therefore, when a peer receives a query command, the peer may look up the routing table to decide which peers can solve the query and then forwards the query to the related peers whose data value boundaries overlap with the search space of the query command. With the mapping and query forwarding, desired data can thus be searched across the federated cloud. The mapping between the search tree nodes and the BATON peers will be described in further detail later below. The construction and update of BATON tree may follow the corresponding processes described in the above-mentioned reference, H. V. Jagadish et al., and thus need not be described or repeated herein for conciseness.

### Federated Cloud Layer

The federated cloud layer provides physical connectivity within a private cloud and between the clouds. A federated cloud may be the deployment and management of multiple external and internal cloud computing services to match business needs. Federated cloud can enable data sharing across different private/organization clouds for scientific research and collaborations, such as a Genome cloud federation. In this regard, data may be owned by individual organization/private cloud in the federation.

To facilitate distributed data search, servers from different private clouds may be connected based on the P2P BATON protocol, corresponding to the Baton peers. If two peers are routing neighbours/partners in the BATON tree structure, a network connection (e.g., a TCP/IP connection) may be maintained between the corresponding servers. The mapping from a P2P network to a federated cloud layer is relatively straightforward since peers are built from servers across the federated cloud. Each private cloud may have at least one node (i.e., corresponding server) mapped to the BATON peer. For a private cloud with large-scale data, the private cloud may have more servers mapped to respective peers to disperse the data for efficient management.

### Mapping Between Index Overlay and Tree-Based P2P Network

To facilitate data search across the federated cloud, some nodes from search trees in the index overlay are selected (e.g., corresponding to the “selected set of nodes” described hereinbefore) and mapped to the respective peers (e.g., corresponding to the “mapped peer node” described hereinbefore) in tree-based P2P network. As described above in an illustrative example, FIG. 7A depicts a schematic drawing showing the mapping of selected nodes from search trees to respective peers of a P2P BATON tree. When a node is selected for mapping, its data value boundaries are published to the corresponding peer in the BATON tree accordingly. With new data insertion and old data deletion/update, the search tree will be updated by splitting/merging nodes or rebalancing itself. As a result, the corresponding peers in the BATON tree may be affected by the update of the search tree. An affected peer needs to change/update its routing table to include new data value boundaries (multi-attribute conditions) of the selected node mapped thereto. Thus, the affected peers will need to send messages to inform their related peers about the changes of data value boundaries, and such message exchanges will lead to network cost eventually.

To reduce or minimize network cost, such as the network cost as described above, a mapping algorithm/method is provided according to various example embodiments of the present invention for selecting nodes from distributed search trees for mapping to respective peers (peer nodes) in the P2P BATON tree. In various example embodiments, the mapping algorithm may be configured to reduce network cost incurred by message exchanges between peers. In this regard, in a cloud environment, network cost is one of the main concerns for cloud deployment and maintenance. In this regard, according to various example embodiments, dynamic mapping is provided to adjust node selection for the case of search tree updates and query pattern changes. The mapping algorithm may include a plurality of functions, including initialization, node selection, and adjustment of node selection.

By way of an example only and without limitation, an exemplary initialization function, a node selection function, and an adjustment of node selection function of the mapping algorithm may be implemented as follow:

```
NodeSelectInitialization (MDT):
Input
      MDT: local multidimensional tree;
Output
      S: a set of nodes selected from MDT;
      C: total cost of selecting S;
begin
      set S = Ø; C = 0;
      for each node nᵢ in MDT do
            update cost Cᵢ for node nᵢ using the cost model;
            if nᵢ ∈root.child then
                  S = S ∪ {nᵢ};
                  C = C + Cᵢ;
            end if
      end for
      return (S, C);
end
NodeSelectAdjustment (S):
Input
      S: a set of nodes selected from MDT;
Output
      S′: a set of nodes selected from MDT;
      C′: total cost of selecting S′;
begin
      S′ = Ø; C′ = 0;
      for each node nᵢ in S do
            (Nₜₘₚ, Cₜₘₚ) = NodeSelect (nᵢ);
            S′ = S′ ∪ Nₜₘₚ;
            C′ = C′ + Cₜₘₚ;
      end for
      return (S′, C′);
end
NodeSelect (n):
Input
      n: a selected node from the MDT;
Output
      N: a set of nodes selected from MDT;
      C: total cost of selecting N;
begin
      set N = {n}; C = Cₙ;
      if n is a leaf node then
            return (N, C);
      else
            Nₜₘₚ = Ø; Cₜₘₚ = 0;
            for ∀nₖ∈n.child do
                  (N′, C′) = NodeSelect (nₖ);
                  Nₜₘₚ = Nₜₘₚ ∪N′;
                  Cₜₘₚ = Cₜₘₚ + C′;
            end for
            if Cₜₘₚ < C then
                  N = Nₜₘₚ; C = Cₜₘₚ;
            end if
      return (N, C);
      end if
end
```

In various embodiments, initially, the selected set of nodes comprises children nodes of a root node of the search tree structure. That is, at the initialization stage, the mapping algorithm may select the nodes at the second level (children of the root node) of each search tree and maps them to the respective peers in P2P BATON tree. In this regard, choosing the second level of nodes at the initialization stage for mapping may be advantageous in that: 1) the cost of publishing data value boundaries of nodes in the second level is relatively low compared to publishing those at the lower levels (e.g., third level or lower); and 2) mapping nodes at the second level leads to fewer false positives in the data search than mapping the root node (at the first level). For example, but without wishing to be bound by theory, when a node in a search tree is selected and mapped to a peer in the Baton network, the data value boundaries of this node will be published to the Baton peer. This may include two processes: the information of the node's data value boundaries is inserted into the peer's routing table, and the peer sends the boundaries information to its related peers. This leads to network cost because the information needs to be transmitted through network to reach the related peers. During node selection initialization, the more nodes are selected, the more data value boundaries need to be published, and the higher network cost is incurred. In a search tree, the number of nodes at the lower levels (e.g., third level or lower) is more than the number of nodes at the second level. Comparing to publishing data value boundaries of all nodes at the second level, it will lead to higher network cost to publish data value boundaries of all nodes at the lower levels. Therefore, the cost of publishing data value boundaries of nodes in the second level is relatively low compared to publishing those at the lower levels (e.g., third level or lower). When a node is selected and mapped to a peer in the Baton network, the node may become the entry node of the search tree when queries are routed to the corresponding peer. The search process may start from this entry node, and traverse downwards following the search tree until leaf nodes. False positive occurs when some node in the traverse path does not return any result for the queries. In a search tree, a node may always contain more data than its children nodes, so its data value boundaries may always be wider than those of the children nodes. Thus, selecting and mapping a higher-level node may have a higher risk of false positive than selecting and mapping a lower-level node. Furthermore, publishing the root node in a search tree may not provide efficient search as its data value boundaries are wide, which will likely lead to high number/level of false positives.

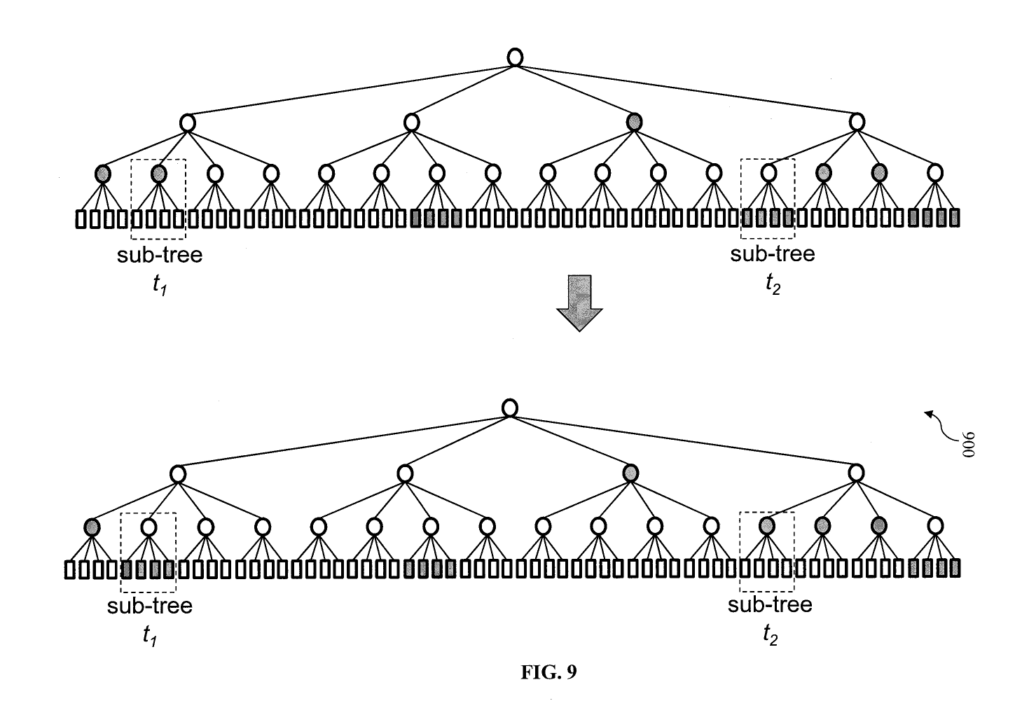

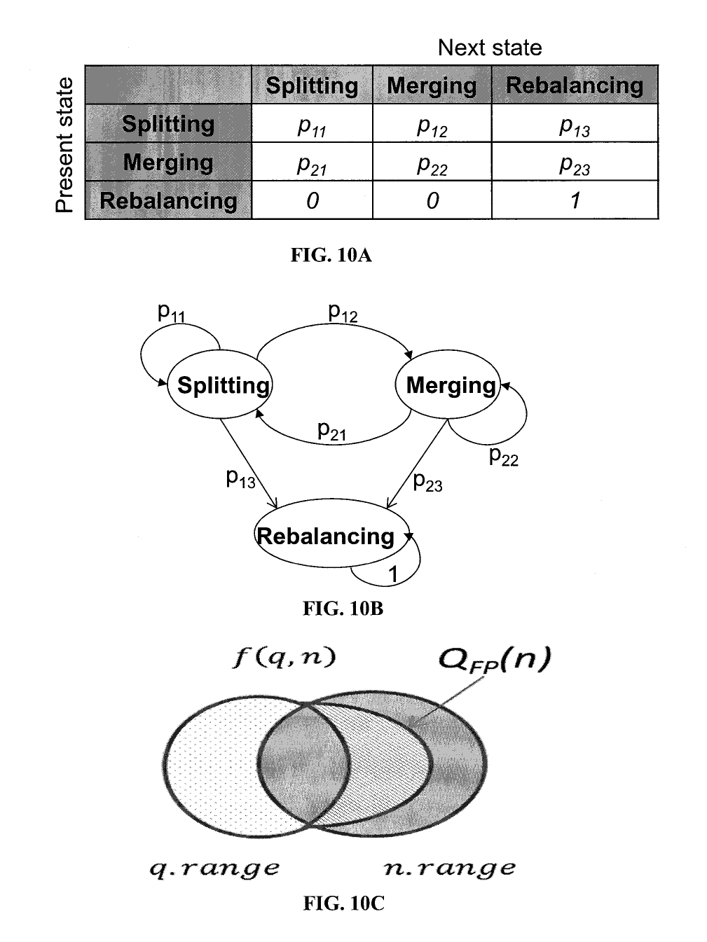

In various embodiments, the node selection strategy may always guarantee index completeness and index uniqueness for the distributed search trees. In this regard, for a set of nodes S selected for mapping, the index may be considered complete if and only if any data in the local dataset is contained by one node in S. In other words, the index is considered complete if and only if for any tuple t in the local dataset, t is contained by one node in S. FIG. 8A depicts a schematic drawing illustrating an example case of index completeness and an example case of failing index completeness. Index completeness guarantees the correctness of query processing. On the other hand, the index may be considered unique if for any node belonging to S, its descendant nodes are not belonging to S, and vice-versa. In other words, the index is considered unique if for a node nᵢ and its ancestor node nⱼ, the following equation is satisfied:

(nᵢ∈S→nⱼ∈(\not in)S)∧(nⱼ∈S→nᵢ∈(\not in)S). (Equation 1)

FIG. 8B depicts a schematic drawing illustrating an example case of index uniqueness and an example case of failing index uniqueness. Index uniqueness minimizes the total cost of the published index, that is, it reduces the index maintenance overhead.

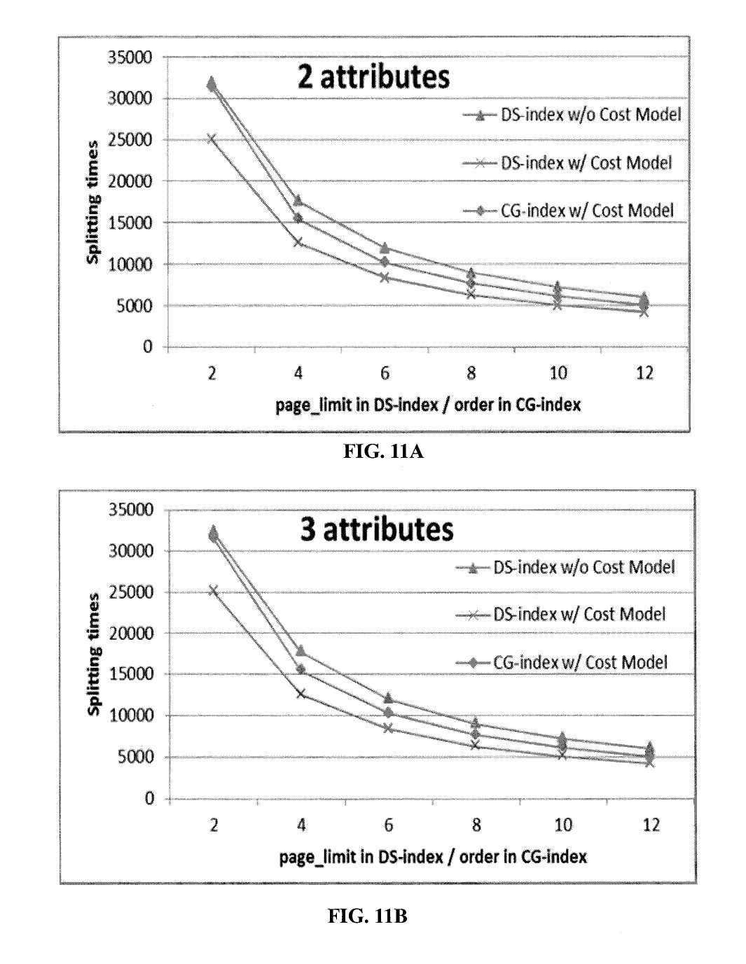

In order to reduce network cost according to various example embodiments of the present invention, the nodes selected for mapping are dynamically adjusted during the operation of federated cloud. In this regard, for each of the selected nodes, the cost of selecting the current node is calculated and compared with the cost of selecting its children nodes. Such a calculation and comparison on the costs between the current node and the children nodes may continue until the leaf nodes. Accordingly, the node selection strategy with the least cost may then be opted. In various example embodiments, node selection adjustment on a search tree may be performed based on whether sub-trees of the search tree are frequently queried or frequently updated. For example, as illustrated in FIG. 9, the selected node of a sub-tree t₁ that is frequently queried but rarely updated may be adjusted/changed to instead select and map the lower-level nodes (its children nodes). On the other hand, the selected nodes of a sub-tree t₂ that is frequently updated but rarely queried may be adjusted/changed to instead select and map the higher-level node. In various example embodiments, the adjustment of node selection may occur when the search tree updates or the query pattern changes meet certain pre-defined/predetermined criteria. For example and without limitation, example criteria may include: more than 40% search tree updates, above 50% query pattern changes, more than 30% false positives in search, and so on.

By way of an example only and without limitation, a method/process of mapping selected nodes in the search tree to the peer nodes of the BATON tree will now be described according to various example embodiments of the present invention. In the example embodiments, each node of the search tree is assigned a unique identification (ID) when it is selected for mapping. The nodes may obtain other nodes' ID information through network gossip. A P2P BATON tree is a balanced tree. In order to map the selected nodes to BATON peers, the set of nodes may be sorted by ID and separated into two groups with equal number of nodes. For example, the medium/middle node (e.g. with the mid-ID) may be mapped to the root peer in BATON tree. The subset of nodes with the smaller IDs (than the middle node) may then be mapped to the peers left to the root peer in BATON tree, and the subset of nodes with the larger IDs (than the middle node) may then be mapped to the peers right to the root peer in BATON tree. For the subset of nodes with the smaller IDs, the nodes are again separated into two groups with equal number of nodes, and the middle node (e.g., with the mid-ID) of this subset of nodes may be mapped to the left-child peer of root. For the subset of nodes with the larger IDs, the nodes are separated into two groups with equal number of nodes, and the middle node (e.g., with the mid-ID) of this subset of nodes may be mapped to the right-child peer of root. The mapping process continues in this manner until all nodes are mapped to the BATON peers.

Accordingly, with the mapping algorithm/method described herein, federated data search across clouds can be achieved with dynamic mapping between distributed search trees and P2P BATON tree. Network cost can be reduced with fewer message exchanges and less network bandwidth consumption, which is an important factor in a cloud environment. A cost model to calculate network cost and facilitate node selection and adjustment is defined/provided according to various example embodiments and will now be described below.

### Cost Model/Framework

A cost model/framework is defined/provided according to various example embodiments of the present invention and applied in the mapping algorithm/method described herein to map nodes between the multi-attribute index overlay (search tree structure) and the tree-based P2P network (P2P tree structure) (e.g., corresponding to “network cost analysis” as described hereinbefore). In various example embodiments, two types of network costs are considered in the cost model: 1) index maintenance cost (e.g., incurred by node splitting and merging, and tree rebalancing); and 2) node selection cost (e.g., regarding selecting and mapping nodes to a BATON tree). In further example embodiments, a Markov chain model (e.g., as described in Meyn et al., “Markov chains and stochastic stability”, Cambridge University Press, 2009, the contents of which being hereby incorporated by reference in its entirety for all purposes) is applied to define the network cost. Various example embodiments may seek to reduce network cost by designing the cost model and to predict future cost based on the historical statistics.

### Index Maintenance Cost

In various example embodiments, index maintenance may be triggered by a search tree update including any one of three scenarios/events: splitting (node splitting), merging (node merging) and rebalancing (tree rebalancing). Network cost is incurred when node splitting/merging and/or tree rebalancing lead to removal/addition of corresponding peers from/to the P2P BATON tree, and may be measured by the number of messages exchanged as a result of such events occurring on the selected node (or respective probabilities of such events occurring on the selected node). That is, the index maintenance cost may be determined based on, for each of the selected set of nodes of the search tree, respective probabilities of a plurality of types of events occurring on the selected node. In various example embodiments, the maintenance cost of node n may be defined as follows:

$$\begin{matrix}{C}_{M} ( n ) = 3 log N ( {p}_{s} ( n ) + {p}_{m} ( n ) ) + T ( n ) \times log N \times {p}_{b} ( n ) \\ = log N ( 3 ( {p}_{s} ( n ) + {p}_{m} ( n ) ) + T ( n ) \times {p}_{b} ( n ) )\end{matrix} \qquad ( Equation 2 )$$

where N is total number of peers in the P2P BATON tree, log N is the average routing cost in the P2P BATON tree, pₛ(n) is probability of splitting node n in the multi-dimensional search tree, pₘ(n) is probability of merging node n with another node in the multi-dimensional search tree, p_{b} (n) is probability of rebalancing the multi-dimensional search tree caused by splitting or merging of node n, and T(n) is the total number of node removal and mapping from/to the P2P BATON tree due to rebalancing.

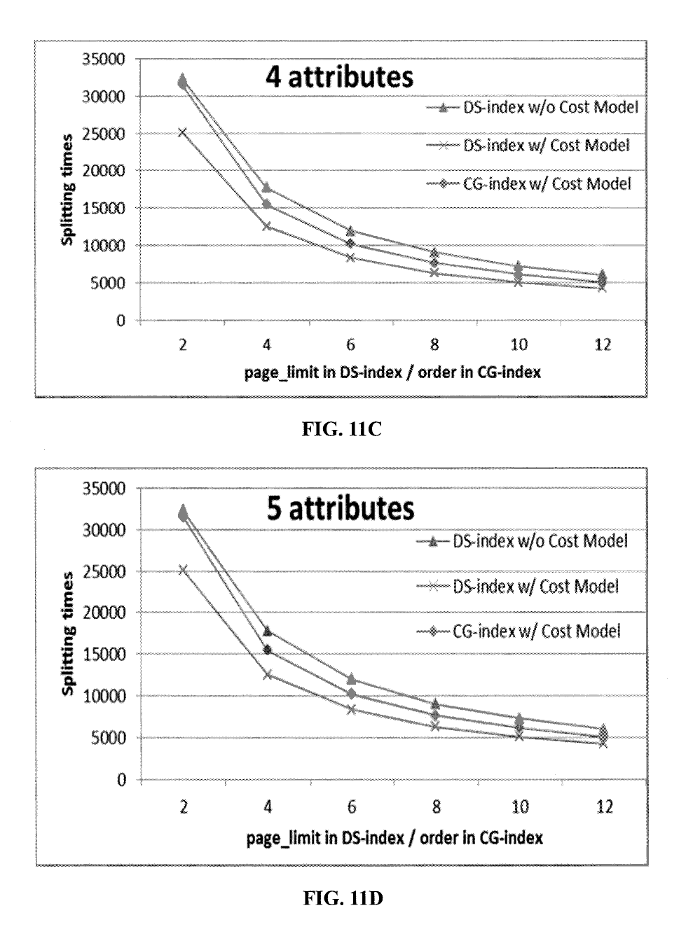

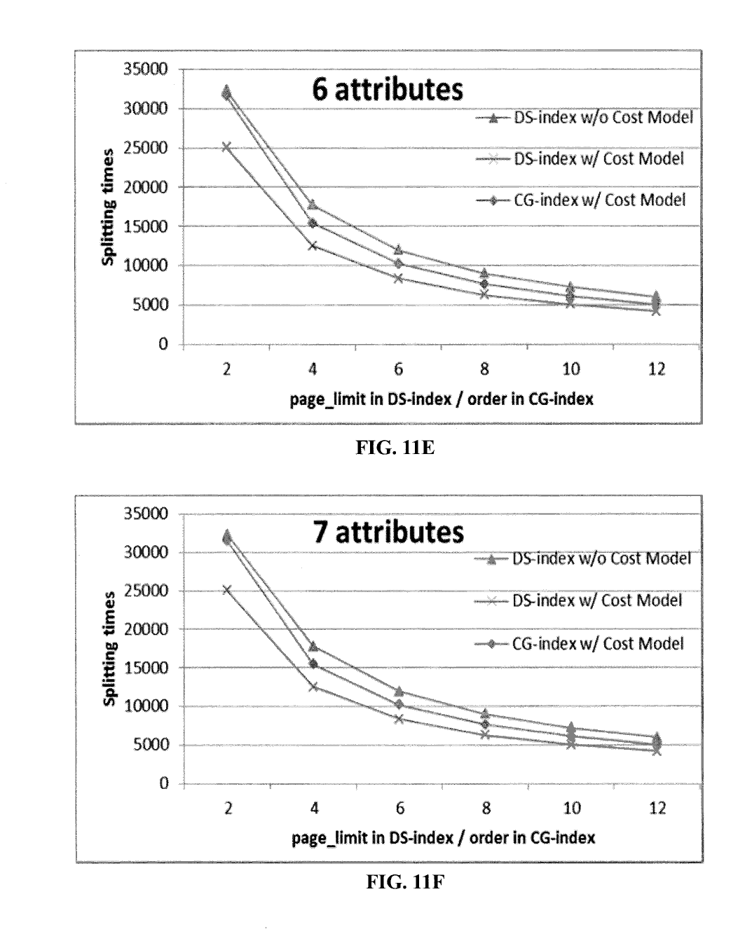

As mentioned above, in various example embodiments, a Markov chain model may be applied to define the network cost. In general, a Markov chain model is a sequence of events with the following properties: 1) an event has a finite number of outcomes, called states, and the process is always in one of these states; 2) at each stage or period of the process, a particular outcome can transition from its present state to any other state or remain 111 the same state; 3) the probability of going from one state to another in a single state is represented by a transition matrix for which the entries in each row lie between 0 and 1; each row sums to 1. These probabilities depend only on the present state and not on past states. In this regard, according to various example embodiments, a three-state Markov chain model is employed, in which the three states are splitting, merging and rebalancing. The transition table and graph are shown in FIGS. 10A and 10B, and the transition matrix may be expressed as:

$$P = ( \begin{matrix}{p}_{11} & {p}_{12} & {p}_{13} \\ {p}_{21} & {p}_{22} & {p}_{23} \\ 0 & 0 & 1\end{matrix} ) \\ where {p}_{11} + {p}_{12} + {p}_{13} = 1 , \\ and {p}_{21} + {p}_{22} + {p}_{23} = 1. \qquad ( Equation 3 )$$

That is, the sum of the probabilities for transitioning from a present state to the next state, which is the sum of the probabilities in each row, equals 1, where all possible outcomes are taken into account.

Accordingly, with the respective probabilities of various events (3 types of events in the above example) provided by the above transition matrix, the maintenance cost of node n may be determined based on respective probabilities of multiple events occurring on the node n using the Markov chain model.

### Node Selection Cost

Node selection cost may include the cost of selecting a set of nodes S and map them to a P2P BATON network. In various example embodiments, the node selection cost mainly considers the false positive cost and the index maintenance cost. In general, false positive occurs when high-level nodes are selected and mapped to the P2P BATON tree, and some sub-queries are routed to the corresponding peers, but some nodes in the search tree cannot return any results for the queries. In various example embodiments, the cost of selecting a set of nodes S may be defined as follows:

$$\begin{matrix}C ( S ) = {Σ}_{n ∈ S} C ( n ) \\ = {Σ}_{n ∈ S} ( {C}_{FP} ( n , Q ) + {C}_{M} ( n ) ) \\ = {Σ}_{n ∈ S} log N ( \vert {Q}_{FP} ( n ) \vert + 3 ( {p}_{s} ( n ) + {p}_{m} ( n ) ) + T ( n ) \times {p}_{b} ( n ) )\end{matrix} \qquad ( Equation 4 )$$

where C(n) is the indexing cost of node n, C(n)=C_{FP}(n)+Cₘ(n), C_{FP}(n) is the false positive cost of node n, Q_{FP}(n)={q|f(q, n)−(q.range∩n.range)≠Ø∧|f(q, n)|≠0}, C_{FP}(n)=log N|Q_{FP}(n)|.

For example, for an indexed node n, the false positives in a set is Q_{FP}(n) incurred by a query. Given a key x, routing to a peer node containing x costs log N messages in the BATON network, where N is the number of peers in the BATON network. Therefore, C_{FP}(n)=log N|Q_{FP}(n)| is the false positive cost of node n. Q_{FP}(n)={q|f(q, n)−(q.range∩n.range)≠Ø∧|f(q, n)≠0}, where q.range represents the query space of query q and n.range is the data space of node n. The overlap of these two spaces represents the desired search results. f(q, n) is the result set returned by node n, including the desired search results and false positives Q_{FP}(n). As an exemplary illustration, FIG. 10C illustrates the relation of q.range, n.range, f(q, n) and Q_{FP}(n).

### Evaluation

To evaluate the performance of the method of facilitating distributed data search in a federated cloud according to various embodiments of the present invention, the performance of the DS-index solution/method described hereinabove according to various example embodiments of the present invention will be evaluated as an example. In particular, the performances among the DS-index with cost model, the DS-index without cost model, and the conventional CG-index with cost model are compared to evaluate the number of node splitting due to data insertions, the number of node merging due to data deletions, the number of tree rebalancing due to node splitting/merging, and the number of messages exchanged between peers. CG-index presents a solution based on B⁺-Tree to address the cloud search problem, which can support single-dimension range search. CG-index includes a cost model to conduct node selection/mapping to P2P. To support multi-dimensional indexing and search, Universal B⁺-Tree (e.g., as described in Rudolf Bayer, “The Universal B-Tree for Multidimensional Indexing: general Concepts”, In WWCA '97, pp. 198-209) is used to replace B⁺-tree in CG-index and all other mechanisms are maintained the same as described in the Wu reference as mentioned hereinbefore. For DS-index, multi-way KD trees are deployed as the search trees for local multi-dimensional data search. All experiments are conducted on a Linux Server with Intel® Xeon® CPU X5650 @ 2.67 GHz and 64 GB of RAM, running 64-bit Ubuntu 10.10. The parameters used in the experiments are listed in Table 1 below.

TABLE 1
Parameters used in experiments

| Parameter | Setting |
|---|---|
| Dimensionality | 2, 3, 4, 5, 6, 7 |
| warmup | 1,000 points |
| Insertions | 50,000 points |
| Deletions | 10,000 points |
| Page limit of multi-way KD tree | 2, 4, 6, 8, 10, 12 |
| Order of Universal B+ tree | 2, 4, 6, 8, 10, 12 |
| Number of peers | 100, 200, . . . , 1,000 |

### Splitting

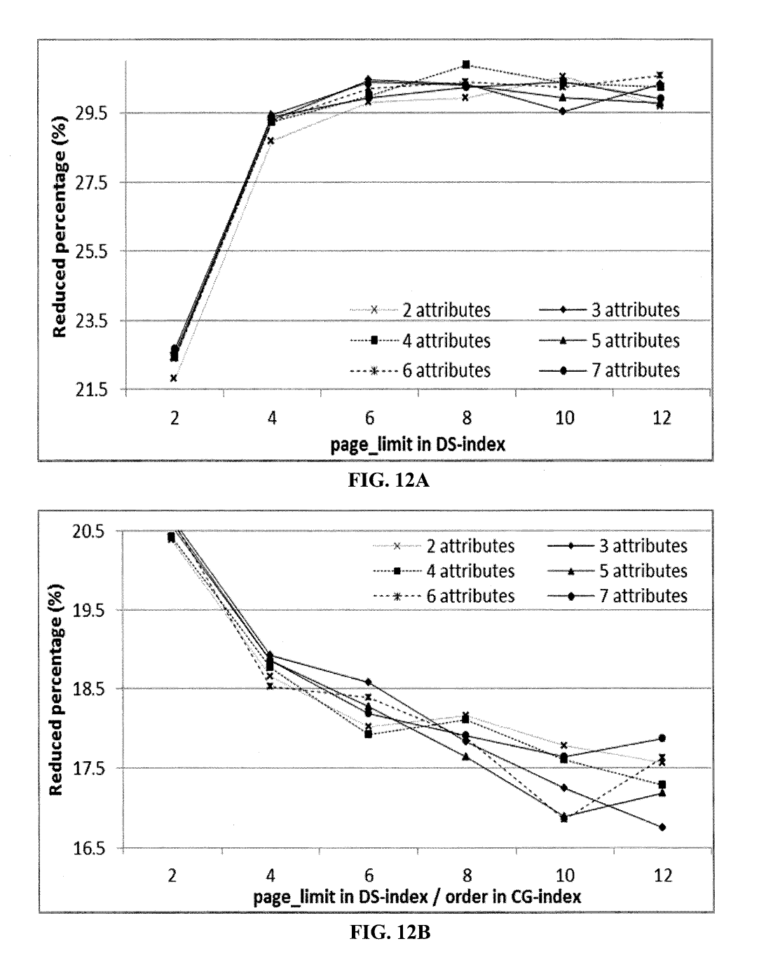

Performance comparison of splitting times (i.e., number of times of node splitting) is presented in FIGS. 11A to 11F using three different cloud indexing approaches: DS-index without cost model, DS-index with cost model, and CG-index with cost model. As can be observed from FIGS. 11A to 11F, DS-index with cost model is significantly more efficient than the other two approaches for data with 2 to 7 attributes because of its excellent cost model. Compared with DS-index without cost model, a reason that DS-index with cost model causes less splitting times may be because its node selection criteria guarantees index completeness and index uniqueness. DS-index with cost model causes fewer splitting times than CG-index with cost model because the former is advantageously more flexible than the latter. For example, the latter explores Universal B⁺-tree based on z-order, which is somewhat difficult to adapt to frequent data insertions.

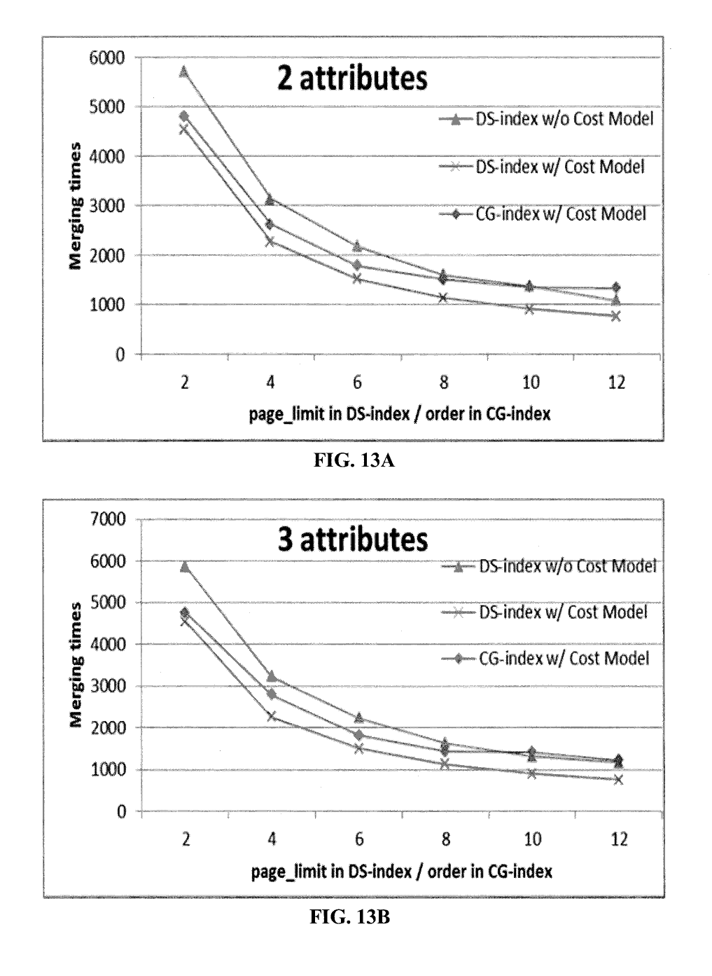

FIGS. 12A and 12B show the performance improvement in splitting times associated with the DS-index with cost model. FIG. 12A demonstrates the reduced percentage in terms of node splits caused by DS-index with cost model, compared with DS-index without cost model. Maximum and minimum reduced percentages are 30.89% and 21.82%, respectively, and average reduced percentage is about 28.72%. FIG. 12B shows the reduced percentage in terms of node splits caused by DS-index with cost model, compared with CG-index with cost model. Maximum and minimum reduced percentages are 20.67% and 16.75%, respectively, and average reduced percentage is 18.37%.

### Merging

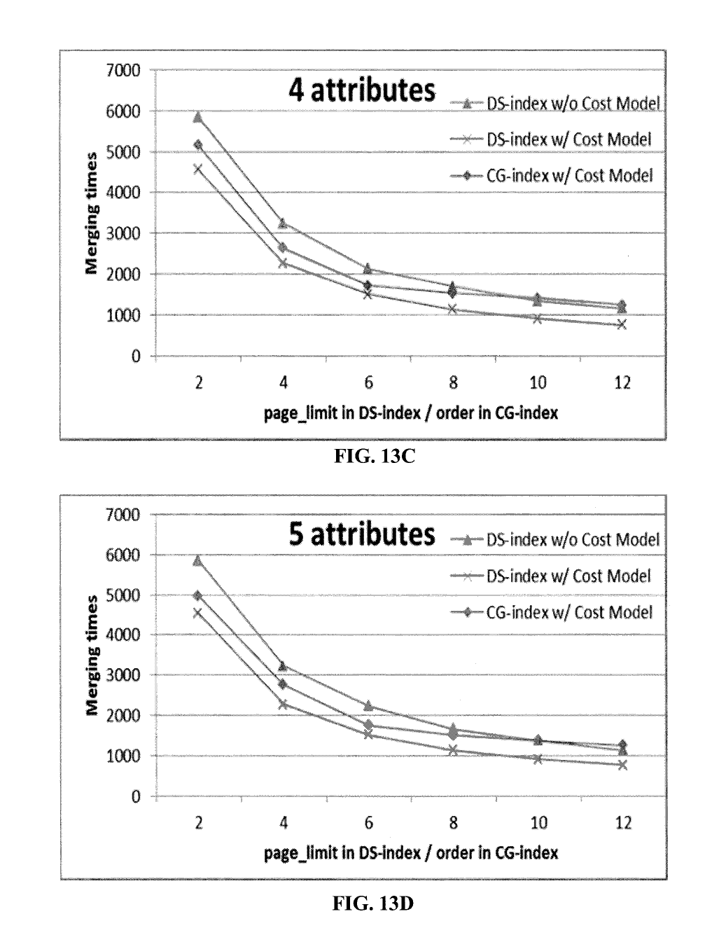

Performance comparison of merging times (i.e., number of times of node merging) is presented in FIGS. 13A to 13F using the same three different cloud indexing approaches as mentioned above. As can be observed from FIGS. 13A to 13F, DS-index with cost model is significantly more efficient than the other two approaches (DS-index without cost model and CG-index with cost model) for data with 2 to 7 attributes because of its excellent cost model. A reason that DS-index with cost model causes fewer merging times than DS-index without cost model may be because its node selection criteria guarantees index completeness and index uniqueness. Compared with CG-index with cost model, DS-index with cost model uses less merging times because it is advantageously more flexible than CG-index with cost model. For example, CG-index with cost model explores Universal B⁺-tree based on z-order, which is somewhat difficult to adapt to frequent data deletions.

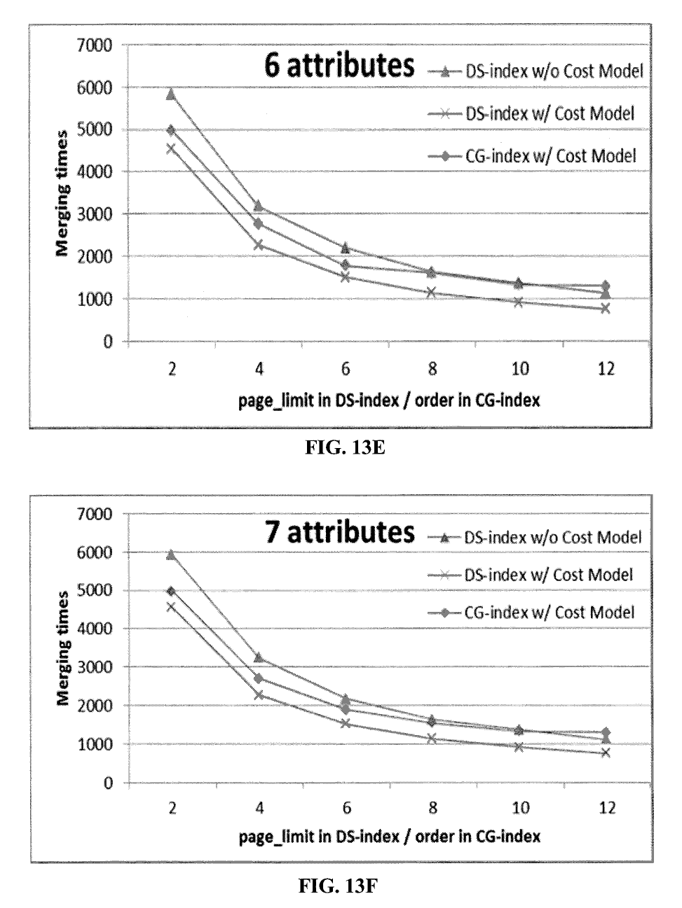

FIGS. 14A to 14B show the performance improvement in merging times associated with the DS-index with cost model. FIG. 14A demonstrates the reduced percentage in terms of node merges caused by DS-index with cost model, compared with DS-index without cost model. Maximum and minimum reduced percentages are 35.13% and 20.44%, respectively, and average reduced percentage is 29.89%. FIG. 14B shows the reduced percentage in terms of node merges caused by DS-index with cost model, compared with CG-index with cost model. Maximum and minimum reduced percentages are 43.03% and 4.56%, respectively, and average reduced percentage is 23.20%.

### Rebalancing

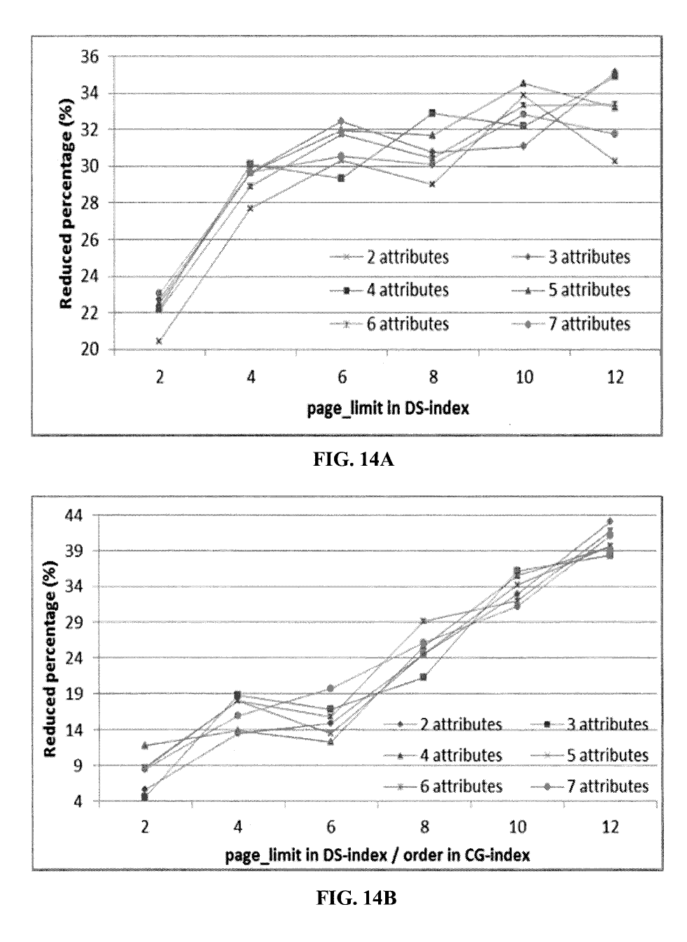

CG-index is based on Universal B⁺-tree, and B⁺-tree is a balanced tree, where all leaf nodes appear at the same level, so there is no rebalancing in CG-index. Accordingly, for the purpose of evaluating tree rebalancing performances, only the DS-index with cost model and the DS-index without cost model are compared. FIG. 15 shows the rebalancing comparison between DS-index with cost model and DS-index without cost model. It can be understood that rebalancing may seldom occur in a multi-way KD tree because of the principal of multi-way KD tree. As shown in FIG. 15, DS-index with cost model causes less rebalancing times (i.e., number of times of tree rebalancing) than DS-index without cost model, and it was found in the experiment that the DS-index with cost model can reduce tree rebalancing times by over 60% than the DS-index without cost model. Rebalancing is caused by node splits and merges, which occur less in DS-index with cost model than in DS-index without cost model.

### Network Cost

Network cost may be measured by the number of messages exchanged between peers. For CG-index, the Wu reference as mentioned hereinbefore did not disclose the content of g(nᵢ) function that represents the number of update messages of a B⁺-tree node nᵢ, because the authors in the Wu reference discarded the complex formula of function g for simplifying the presentation. In addition, the values of α and β in CG-index are also not clear (the authors only listed α/β=1/2). Therefore, for the purpose of evaluating network cost performances, the network cost of CG-index is omitted. Accordingly, only the DS-index with cost model and the DS-index without cost model in terms of network cost are compared.

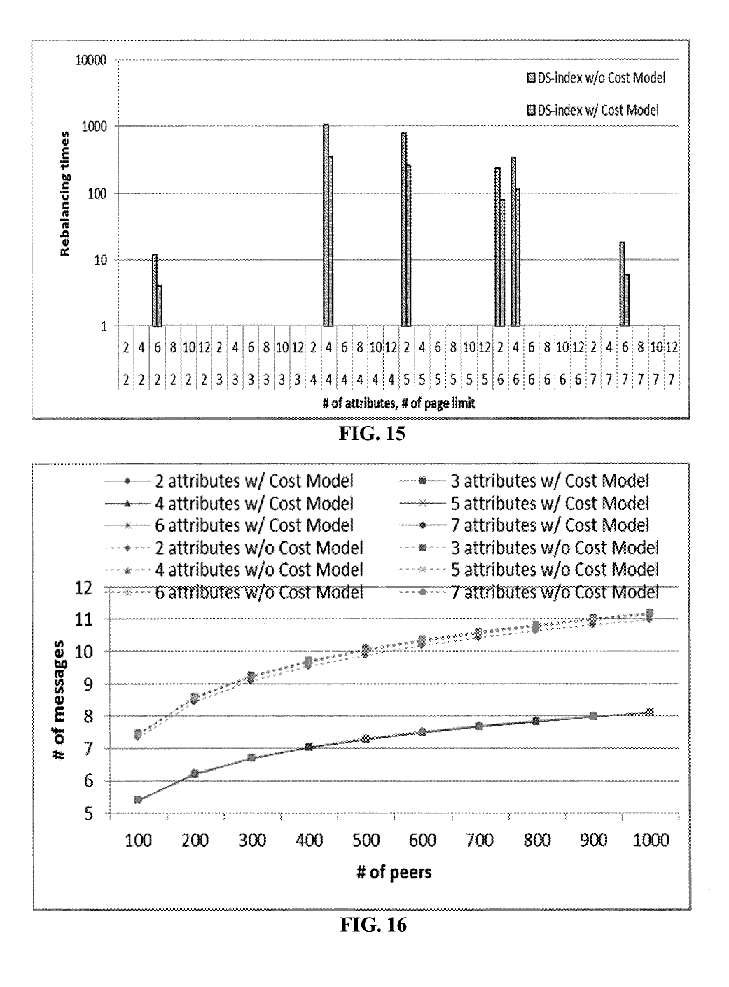

FIG. 16 shows the network costs for DS-index without cost model and DS-index with cost model. Compared with DS-index without cost model, it was found that DS-index with cost model reduced 27.65% in maximum and 26.40% in minimum respectively in terms of the number of messages exchanged, while the average reduced percentage is 27.32%. Accordingly, this demonstrates that DS-index with cost model is better than DS-index without cost model in network overhead because its excellent cost model reduces splitting times, merging times and rebalancing times compared to DS-index without cost model. In addition, DS-index is scalable as shown in FIG. 16, and DS-index with cost model is better than DS-index without cost model in scalability because, for example, its cost model makes it better than DS-index without cost model with smaller sub-linear increase.

Accordingly, the experiments conducted have shown that, the DS-index solution with cost model can save the computation resource and reduce network bandwidth consumption, e.g., by around 30% compared to the DS-index solution without cost model, and by around 20% compared to the existing CG-index solution.

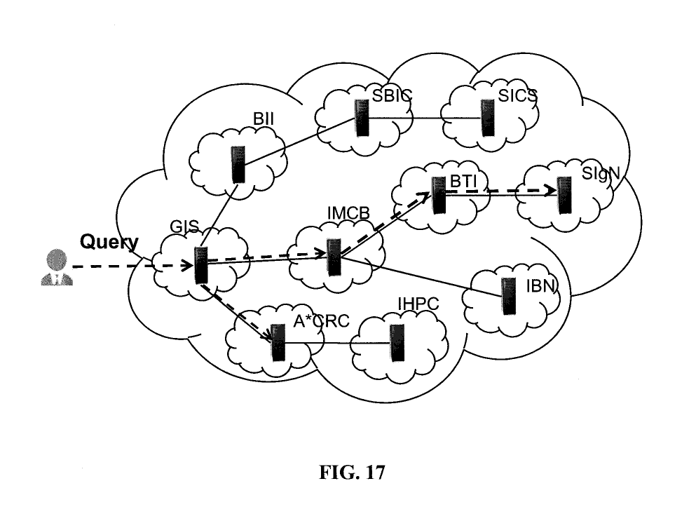

FIG. 17 depicts a schematic drawing of a federated cloud comprising multiple private clouds for different departments or organizations as an exemplary case. For example, in the exemplary case, a user at the GIS organization may wish to query specific genome data satisfying multiple data attributes in the federated cloud, such as using a multi-attribute range query: {size between (100 KB, 1 GB); date between (01/01/2015, 30/06/2015); type=“WGS”; organism=“Zebrafish”}. In this example case, some data may be found inside the GIS cloud, but some data are located in the private clouds of other organizations. Based on the method of facilitating distributed data search in a federated cloud according to various embodiments of the present invention, the query may be forwarded to the destination/target clouds following the P2P routing tree, whereby the routing tree is shown using full lines and the query forwarding/routing is shown using dashed arrows in FIG. 17. As shown in FIG. 17, the destination/target clouds may be the GIS cloud (local), the A*CRC cloud (remote cloud), the IMCB cloud (remote cloud) and the SIgN cloud (remote cloud). Accordingly, the method of facilitating distributed data search according to various embodiments of the present invention advantageously avoids query flooding to all clouds as for example shown in FIG. 2 according to conventional techniques for federated cloud search.

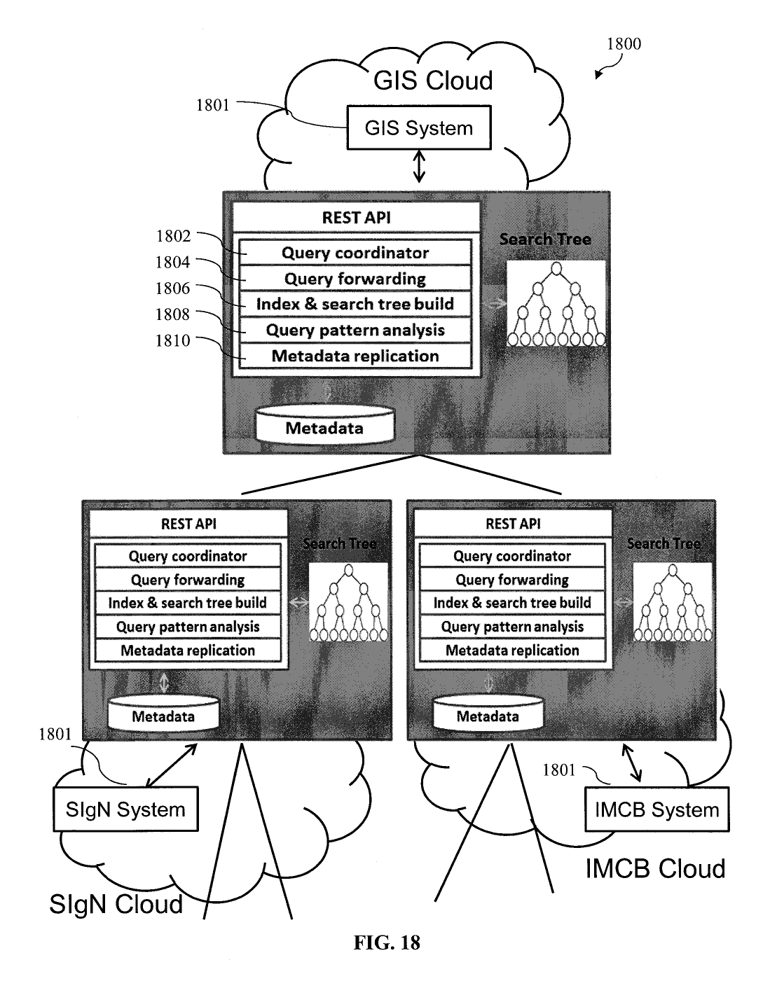

As described hereinbefore with reference to FIG. 4, there is provided a system 400 for facilitating distributed data search in a federated cloud. For example, such a system may be deployed at each of the clouds of the federated cloud for facilitating distributed data search in the federated cloud. For illustration purposes only and without limitation, FIG. 18 depicts a schematic drawing of a federated cloud comprising three private clouds at three different organizations (e.g., GIS cloud, SIgN cloud, and IMCB cloud), each private cloud having a system 1801 deployed therein for facilitating distributed data search in the federated cloud. In the example, each system 1801 may comprise a query coordinator module/circuit 1802, a query forwarding module/circuit 1804, an index and search tree build module/circuit 1806, a query pattern analysis module/circuit 1808, and a metadata replication module/circuit 1810. In various example embodiments, the query coordinator module 1802 may be configured to distribute query commands to distributed search engines and consolidate search results from distributed search engines. The query forwarding module 1804 may be configured to route queries following the P2P Baton network. The index and search tree build module 1806 may be configured to build and update multidimensional trees for each private cloud/organization, and may correspond or relate to the search tree generator module 402 shown in FIG. 4. The query pattern analysis module 1808 may be configured to analyse query patterns and recommend/command rebalancing of search trees. For example, the results of query pattern analysis may lead to the adjustment of node selection, and may correspond or relate to the mapping module 404 shown in FIG. 4. The metadata replication module 1810 may be configured to replicate metadata from each private cloud/organization to a central cloud for metadata management, and may correspond or relate to the attribute condition informing module 406 shown in FIG. 4.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method of facilitating distributed data search in a federated cloud, the method comprising:
generating, at a computing cloud of the federated cloud, a search tree structure for indexing a data set in the computing cloud, the search tree structure comprising a plurality of nodes, each node being associated with a data subset of the data set and a plurality of types of attribute conditions satisfied by said data subset associated with the node;
mapping a selected set of nodes of the search tree structure to respective peer nodes of a peer-to-peer tree structure spanning a plurality of servers in a plurality of computing clouds of the federated cloud, the peer-to-peer tree structure configured for routing a query for searching a data item in the federated cloud and comprises a plurality of peer nodes, the plurality of peer nodes corresponding to the plurality of servers, respectively, in the plurality of computing clouds; and
informing, for each selected node, the plurality of types of attribute conditions associated with the selected node to the corresponding mapped peer node such that the corresponding mapped peer node has associated therewith the plurality of types of attribute conditions.

2. The method according to claim 1, wherein each mapped peer node of the plurality of peer nodes has associated therewith routing information, the routing information comprising the plurality of types of attribute conditions informed by the corresponding selected node and a plurality of types of attribute conditions associated with each peer node of a subset of the plurality of peer nodes related to the mapped peer node.

3. The method according to claim 2, wherein each peer node of the subset of the plurality of peer nodes related to the mapped peer node is a parent peer node, a children peer node, an adjacent peer node, or a neighbour peer node to the mapped peer node in the peer-to-peer tree structure.

4. The method according to claim 2, wherein the routing information comprises a routing table including a peer node entry for each peer node related to the mapped peer node, each peer node entry comprising a peer node identifier of the related peer node and the plurality of types of attribute conditions associated with the related peer node.

5. The method according to claim 1, wherein the plurality of types of attribute conditions comprises a plurality of data value boundaries for different types of data attributes.

6. The method according to claim 1, wherein the selected set of nodes comprises children nodes of a root node of the search tree structure.

7. The method according to claim 1, wherein mapping the selected set of nodes comprises:
performing a network cost analysis on the peer-to-peer tree structure associated with mapping the selected set of nodes to the respective peer nodes of the peer-to-peer tree structure; and
adjusting the selected set of nodes for mapping to the respective peer nodes based on the network cost analysis.

8. The method according to claim 7, wherein performing the network cost analysis comprises:
determining, for the selected set of nodes, a network cost on the peer-to-peer tree structure associated with mapping the selected set of nodes to the respective peer nodes of the peer-to-peer tree structure;
determining, for a second set of nodes of the search tree structure, a network cost on the peer-to-peer tree structure associated with mapping the second set of nodes to the respective peer nodes of the peer-to-peer tree structure, the second set of nodes being the selected set of nodes with one or more selected nodes thereof replaced by corresponding one or more children nodes thereof;
comparing the network cost determined for the selected set of nodes with the network cost determined for the second set of nodes; and
adjusting the selected set of nodes to conform with the second set of nodes if the network cost determined for the second set of nodes is lower than the network cost determined for the selected set of nodes.

9. The method according to claim 8, wherein determining the network cost for the selected set of nodes comprises determining an index maintenance cost on the peer-to-peer tree structure associated with the selected set of nodes, wherein the index maintenance cost is determined based on, for each of the selected set of nodes, a probability of an event occurring on the selected node.

10. The method according to claim 9, wherein the index maintenance cost is determined based on, for each of the selected set of nodes, respective probabilities of a plurality of types of events occurring on the selected node, the plurality of types of events comprising a node splitting event whereby the selected node splits in the search tree structure, a node merging event whereby the selected node merges with another node in the search tree structure, and a rebalancing event whereby the search tree structure is caused to rebalance by the splitting or merging event on the selected node.

11. The method according to claim 1, wherein the peer-to-peer tree structure is a Balanced Tree Overlay Network (BATON) tree structure.

12. A system for facilitating distributed data search in a federated cloud, the system comprising:
a search tree generator module configured to generate, at a computing cloud of the federated cloud, a search tree structure for indexing a data set in the computing cloud, the search tree structure comprising a plurality of nodes, each node being associated with a data subset of the data set and a plurality of types of attribute conditions satisfied by said data subset associated with the node;
a mapping module configured to map a selected set of nodes of the search tree structure to respective peer nodes of a peer-to-peer tree structure spanning a plurality of servers in a plurality of computing clouds of the federated cloud, the peer-to-peer tree structure configured for routing a query for searching a data item in the federated cloud and comprises a plurality of peer nodes, the plurality of peer nodes corresponding to the plurality of servers, respectively, in the plurality of computing clouds; and
an attribute condition informing module configured to inform, for each selected node, the plurality of types of attribute conditions associated with the selected node to the corresponding mapped peer node such that the corresponding mapped peer node has associated therewith the plurality of types of attribute conditions.

13. The system according to claim 12, wherein each mapped peer node of the plurality of peer nodes has associated therewith routing information, the routing information comprising the plurality of types of attribute conditions informed by the corresponding selected node and a plurality of types of attribute conditions associated with each peer node of a subset of the plurality of peer nodes related to the mapped peer node.

14. The system according to claim 13, wherein the routing information comprises a routing table including a peer node entry for each peer node related to the mapped peer node, each peer node entry comprising a peer node identifier of the related peer node and the plurality of types of attribute conditions associated with the related peer node.

15. The system according to claim 12, wherein the plurality of types of attribute conditions comprises a plurality of data value boundaries for different types of data attributes.

16. The system according to claim 12, wherein the mapping module is further configured to:
perform a network cost analysis on the peer-to-peer tree structure associated with mapping the selected set of nodes to the respective peer nodes of the peer-to-peer tree structure; and
adjust the selected set of nodes for mapping to the respective peer nodes based on the network cost analysis.

17. The system according to claim 16, wherein performing the network cost analysis comprises:
determining, for the selected set of nodes, a network cost on the peer-to-peer tree structure associated with mapping the selected set of nodes to the respective peer nodes of the peer-to-peer tree structure;
determining, for a second set of nodes of the search tree structure, a network cost on the peer-to-peer tree structure associated with mapping the second set of nodes to the respective peer nodes of the peer-to-peer tree structure, the second set of nodes being the selected set of nodes with one or more selected nodes thereof replaced by corresponding one or more children node thereof;
comparing the network cost determined for the selected set of nodes with the network cost determined for the second set of nodes; and
adjusting the selected set of nodes to conform with the second set of nodes if the network cost determined for the second set of nodes is lower than the network cost determined for the selected set of nodes.

18. The system according to claim 17, wherein determining the network cost for the selected set of nodes comprises determining an index maintenance cost on the peer-to-peer tree structure associated with the selected set of nodes, wherein the index maintenance cost is determined based on, for each of the selected set of nodes, a probability of an event occurring on the selected node.

19. The system according to claim 18, wherein the index maintenance cost is determined based on, for each of the selected set of nodes, respective probabilities of a plurality of types of events occurring on the selected node, the plurality of types of events comprising a node splitting event whereby the selected node splits in the search tree structure, a node merging event whereby the selected node merges with another node in the search tree structure, and a rebalancing event whereby the search tree structure is caused to rebalance by the splitting or merging event on the selected node.

20. A computer program product, embodied in one or more computer-readable storage mediums, comprising instructions executable by one or more computer processors to perform a method of facilitating distributed data search in a federated cloud, the method comprising:
generating, at a computing cloud of the federated cloud, a search tree structure for indexing a data set in the computing cloud, the search tree structure comprising a plurality of nodes, each node being associated with a data subset of the data set and a plurality of types of attribute conditions satisfied by said data subset associated with the node;
mapping a selected set of nodes of the search tree structure to respective peer nodes of a peer-to-peer tree structure spanning a plurality of servers in a plurality of computing clouds of the federated cloud, the peer-to-peer tree structure configured for routing a query for searching a data item in the federated cloud and comprises a plurality of peer nodes, the plurality of peer nodes corresponding to the plurality of servers, respectively, in the plurality of computing clouds; and
informing, for each selected node, the plurality of types of attribute conditions associated with the selected node to the corresponding mapped peer node such that the corresponding mapped peer node has associated therewith the plurality of types of attribute conditions.
